(19) United States
(12) Patent Application Publication
(10) Pub. No.: US 2025/0013189 A1
(43) Pub. Date: Jan. 9, 2025

(54) DEVELOPING CARTRIDGE

(71) Applicants: E-Z INK TECHNOLOGY CO., LTD., Zhuhai (CN); ZHUHAI YANQI TECHNOLOGY CO., LTD., Zhuhai (CN)

(72) Inventor: Yu ZHU, Zhangjiajie (CN)

(73) Assignees: E-Z INK TECHNOLOGY CO., LTD., Zhuhai (CN); ZHUHAI YANQI TECHNOLOGY CO., LTD., Zhuhai (CN)

(21) Appl. No.: 18/889,760

(22) Filed: Sep. 19, 2024

Related U.S. Application Data
(63) Continuation-in-part of application No. PCT/CN2023/082426, filed on Mar. 20, 2023.

(30) Foreign Application Priority Data
Mar. 20, 2022 (CN) 202220604017.8
Jun. 22, 2022 (CN) 202210716526.4
Jul. 25, 2022 (CN) 202221938084.X

(51) Int. Cl. G03G 21/16; G03G 15/08; G03G 21/18

(52) U.S. Cl. CPC G03G 21/1676; G03G 15/0806; G03G 15/0889; G03G 21/1857; G03G 2221/163; G03G 2221/1892

(57) ABSTRACT

Disclosed is a developing cartridge configured to be removably mounted in a main assembly of an imaging apparatus. In some embodiments disclosed, the developing cartridge includes: a cartridge body; a drive force receiving unit including a coupling member, disposed at a first end of the developing cartridge, configured to receive a drive force from the imaging apparatus; a driving member, disposed at the first end of the developing cartridge, configured to receive the drive force and move; a transmission member, receiving a force from the driving member to cause at least a portion of the transmission member to move along a longitudinal direction of the cartridge body; and a detected member provided at a second end of the developing cartridge, configured to be driven by the transmission member.

### CROSS-REFERENCE TO RELATED APPLICATIONS

This application is a continuation-in-part of International Application No. PCT/CN2023/082426, filed on Mar. 20, 2023, which claims priority to Chinese Patent Application No. 202220604017.8, filed on Mar. 20, 2022, Chinese Patent Application No. 202210716526.4, filed on Jun. 22, 2022, and Chinese Patent Application No. 202221938084.X, filed on Jul. 25, 2022. All of the aforementioned patent applications are hereby incorporated by reference in their entireties.

### TECHNICAL FIELD

The present disclosure relates to the field of electrophotographic imaging apparatus, and in particular to a developing cartridge.

### BACKGROUND

As is known, as an electrophotographic type imaging apparatus, such an imaging apparatus includes a main assembly, a photoconductor drum provided in the main assembly, and a developing cartridge for supplying developer to the photoconductor drum.

Such an imaging apparatus includes a detection unit for judging information about a developing cartridge installed in the imaging apparatus. For example, the detection unit is configured to determine whether a newly installed developing cartridge in the imaging apparatus is a new product, or the size and capacity information of the developing cartridge, etc.

In this type of imaging apparatus, a developing cartridge can be mounted in a removable manner to a main assembly of the imaging apparatus, and the main assembly is provided with a transmission mechanism and a light sensor. The developing cartridge rotatably supports a detected mechanism, and the detected mechanism is provided with a protruding portion (detected member) that can contact and push the transmission mechanism. When the developing cartridge is mounted to the main assembly, the detected mechanism is driven to rotate and the protruding part pivots the transmission mechanism. The optical sensor detects the pivoting motion of the transmission mechanism, and the imaging apparatus determines the information of the developing cartridge based on the detection result of the optical sensor.

Similarly, in addition to judging the information of the developing cartridge by the detection result of the light sensor, there is also a way of detecting the information of the developing cartridge by means of capacitance, and the way of detecting the capacitance may be that the pivoting motion of the protruding portion contacting the transmission mechanism causes the capacitance to change, and the information of the developing cartridge is thus judged accordingly. Another way is to judge the information of the developing cartridge by the change of voltage or current of the circuit by switching on and off, and specifically, the switch can be disconnected or connected by the pivoting motion of the protruding part contacting the transmission mechanism.

There exists a developing cartridge in which a drive force receiving unit is provided at a first end along a longitudinal direction, a detected member is provided at a second end opposite to the first end, and a rotary shaft configured to receive a rotational drive force and rotate is provided between the first end and the second end so as to be configured to transmit a rotational drive force of the drive force receiving unit from the first end to the second end of the developing cartridge, thereby driving the detected member provided at the second end. In this case, a stirring member is rotatably provided in the developing cartridge for stirring the developer, and the rotational shaft of the stirring member is configured to transmit the rotational drive force for driving the detected member, which results in the rotational shaft of the stirring member being subjected to the force of stirring the developer and driving the detected member at the same time, and there is a risk of deformation or even fracture.

### SUMMARY

The main object of the present disclosure is to provide a new driven structure of the detected member, wherein there is no need to transmit a force to drive the detected member through the rotational shaft of the stirring member, in order to eliminate the risk that the rotational shaft of the stirring member is susceptible to deformation or even fracture.

The object of the present disclosure can be achieved by the following technical solutions.

A developing cartridge removably mountable in a main assembly of an imaging apparatus comprises: a cartridge body; a drive force receiving unit comprising a coupling member, provided at a first end of the developing cartridge and configured to receive a drive force from the imaging apparatus; a driving member, provided at the first end of the developing cartridge and configured to receive the drive force and move; a transmission member configured to receive a force from the driving member, wherein the force causes at least a portion of the transmission member to move in a longitudinal direction of the cartridge body; and a detected member, provided at a second end of the developing cartridge and configured to be driven by the transmission member.

In some embodiments, the detected member is configured as a sliding member, and is configured to slide in response to a pushing force from the transmission member.

In some embodiments, the drive force receiving unit further comprises a stirring member gear, and the driving member is configured to engage with the stirring member gear.

In some embodiments, the driving member comprises a cam member, the cam member including a main body portion and a cam portion configured to push the transmission member, and wherein the cam portion protrudes from an end face of the main body portion along the longitudinal direction of the cartridge body.

In some embodiments, the cartridge body is provided with a sliding groove portion, and at least a portion of the transmission member is disposed in the sliding groove portion.

In some embodiments, the sliding groove portion protrudes from an outer surface of the cartridge body and is positioned higher than the transmission member, and wherein a side of the sliding groove portion facing the transmission member is configured to contact an outer surface of the transmission member, thereby restricting movement of the transmission member along an up-down direction of the developing cartridge.

In some embodiments, the sliding groove portion is provided on an upper side of the cartridge body, the transmission member is slidably accommodated in the sliding groove portion, and an upper surface of the transmission member is flush with or lower than an upper surface of the cartridge body.

In some embodiments, two sliding groove portions are provided on opposite sides of the transmission member; or multiple sliding groove portions are spaced apart along the longitudinal direction of the cartridge body.

In some embodiments, the detected member is configured to move in a front-rear direction of the developing cartridge.

In some embodiments, the developing cartridge further comprises a rotating body configured to receive the drive force transmitted by the coupling member and rotate, wherein the detected member is configured to rotate or pivot with the rotation of the rotating body.

In some embodiments, the driving member comprises a first transmission body, a rotational axis of the first transmission body being perpendicular to a rotational axis of the coupling member, wherein the first transmission body is provided with a first rotational force receiving portion for receiving rotational force, the first rotational force receiving portion comprising a gear portion.

In some embodiments, the transmission member comprises a flexible transmission member, the flexible transmission member connecting the first transmission body and the rotating body; wherein rotation of the first transmission body is configured to drive the flexible transmission member to rotate and move along the longitudinal direction of the cartridge body, thereby causing the rotating body to rotate through the flexible transmission member.

In some embodiments, the driving member comprises a first transmission body and a second transmission body, wherein the second transmission body is configured to receive a drive force from the drive force receiving unit, the first transmission body receiving the drive force from the second transmission body; wherein both the first transmission body and the second transmission body comprise bevel gear structures.

In some embodiments, the detected member is provided on the rotating body and is configured to rotate with the rotating body.

In some embodiments, the driving member comprises a first transmission body and a flexible transmission member; wherein one end of the flexible transmission member is wound on or connected to the first transmission body, and the other end is wound on the rotating body, with the winding directions of the flexible transmission member on the first transmission body and the rotating body being opposite to each other.

In some embodiments, the detected member is provided on and protrudes from an outer surface of the flexible transmission member.

In some embodiments, the transmission member comprises a flexible transmission member configured to operatively connect the driving member and the rotating body, thereby causing the rotating body to rotate; wherein the driving member comprises a first transmission body and a second transmission body, the first transmission body being provided with a first rotational force receiving portion for receiving rotational force and a first mounting portion for mounting the flexible transmission member, the second transmission body being provided with a second rotational force receiving portion and a rotational force transmitting portion, wherein the second rotational force receiving portion is configured to receive rotational drive force from the drive force receiving unit, and the rotational force transmitting portion is connected to the first rotational force receiving portion to transmit rotational drive force to the first transmission body.

In some embodiments, the first rotational force receiving portion comprises a first gear portion, the first mounting portion comprises an annular groove provided on a shaft portion of the first transmission body, the annular groove rotating with the rotation of the first gear portion; wherein the second rotational force receiving portion comprises a second gear portion, and the rotational force transmitting portion comprises a screw rod portion that meshes with the first gear portion for transmission.

In some embodiments, the developing cartridge further comprises a direction changing member, wherein the flexible transmission member is supported by the direction changing member to change direction by bending downward from an upper side.

In some embodiments, the developing cartridge further comprises a transmission interruption mechanism configured to interrupt the drive force transmitted from the first transmission body to the detected member, thereby causing the detected member to stop moving; wherein the transmission interruption mechanism comprises a smooth surface provided on an inner side of the flexible transmission member, such that when the smooth surface moves to a position in contact with the first transmission body, the flexible transmission member stops rotating.

In some embodiments, the driving member comprises a main body portion, a gear portion configured to engage with the drive force receiving unit, and an action portion configured to push the transmission member; wherein the transmission member is movable between a first position not pushed by the action portion and a second position pushed by the action portion.

In some embodiments, the action portion extends along an axial direction or a radial direction with respect to a rotational axis of the driving member.

In some embodiments, a rotational axis of the driving member is either perpendicular or parallel to a rotational axis of the coupling member.

In some embodiments, the transmission member is a sliding member comprising: a force receiving portion; and a rod portion slidably disposed on the cartridge body; wherein the action portion is configured to push the force receiving portion, causing the sliding member to slide along the longitudinal direction of the cartridge body.

In some embodiments, the transmission member is a pivoting member comprising: a force receiving portion; and a rod portion pivotally disposed on the cartridge body; wherein the action portion is configured to push the force receiving portion, causing the pivoting member to pivot in either a front-rear direction or an up-down direction of the cartridge body, resulting in at least a portion of the pivoting member moving along the longitudinal direction of the cartridge body.

In some embodiments, the developing cartridge further comprises a clutch mechanism configured to selectively interrupt transmission of the drive force to the transmission member.

In some embodiments, the clutch mechanism comprises a notched portion provided on an outer side of the main body portion, and wherein the action portion is configured to engage with the notched portion to interrupt the transmission of the drive force.

In some embodiments, the clutch mechanism comprises: a forcing structure configured to move at least a portion of the driving member, thereby interrupting the transmission of the drive force; and a retracting structure configured to provide a displacement space for the movement of the at least a portion of the driving member.

In some embodiments, the driving member and the drive force receiving unit form a geared engagement, and wherein the clutch mechanism comprises a missing tooth portion provided on the driving member.

In some embodiments, the detected member is pivotally connected, fixedly connected, or integrally molded with the transmission member.

In some embodiments, the drive force receiving unit further comprises one or more of a development roller gear, a stirring member gear, a powder feed roller gear, and an idler wheel. The driving member can engage with one of the development roller gear, stirring member gear, powder feed roller gear, and idler wheel, for example, engaging with the stirring member gear. The cartridge body is provided with a first side wall and a second side wall along its length, and at least a portion of the transmission member is disposed between the first side wall and the second side wall.

In some embodiments, the driving member is a cam member, the action portion is a cam portion, and the developing cartridge further comprises a resilient member, the resilient member being configured to apply a force to the transmission member to enable the transmission member to move in a direction from the second position to the first position.

In some embodiments, the cam member has a first bevel gear teeth portion and the drive force receiving unit has a second bevel gear teeth portion engaged with the first bevel gear teeth portion.

In some embodiments, the driving member is a grooved cam wheel member, the grooved cam wheel member comprising a guiding groove, the action portion being provided within the guiding groove or forming part of the guiding groove.

In some embodiments, the developing cartridge further comprises a rotating body, the rotating body having a rotational axis which intersects with the rotational axis of the coupling member; the driving member comprises a first transmission body having a rotational axis perpendicular to the rotational axis of the coupling member, the first transmission body being provided with a first rotational force receiving portion and a first mounting portion; the transmission member is a flexible transmission member, the flexible transmission member connecting the first mounting portion and the rotating body to rotate the rotating body, the detected member moving with the rotating body or the flexible transmission member to be detectable by a detection unit.

In some embodiments, the driving member further comprises a second transmission body, the second transmission body being provided with a second rotational force receiving portion and a rotational force transmitting portion whose rotational axis intersects with the rotational axis of the first rotational force receiving portion; wherein the second rotational force receiving portion engages with the drive force receiving unit to receive a rotational drive force, and the first rotational force receiving portion engages with the rotational force transmitting portion.

In some embodiments, the second rotational force receiving portion is a gear portion, one of the first rotational force receiving portion and the rotational force transmitting portion is a screw portion, and the other is a gear portion. Alternatively, both the first rotational force receiving portion and the rotational force transmitting portion are bevel gear teeth portions.

In some embodiments, the detected member is provided on an outer surface of the flexible transmission member or on an outer surface of the rotating body.

In some embodiments, the flexible transmission member is a flexible belt or chain, with one end of the flexible belt or chain being fitted to the shaft of the first transmission body and the other end being fitted to the shaft of the rotating body.

In some embodiments, the detected member is provided on an outer surface of the flexible belt or chain, or on an outer surface of the rotating body.

In some embodiments, the flexible transmission member is a flexible cord or wire, with one end of the flexible cord or wire being connected to a shaft portion of the first transmission member and the other end being wrapped around a shaft portion of the rotating body. The detected member is provided on an outer surface of the rotating body.

In some embodiments, an upper side of the cartridge body is further provided with an accommodating groove, at least a portion of the transmission member being provided in the accommodating groove.

In some embodiments, the developing cartridge further comprises a covering portion covering at least a portion of the transmission member.

In a developing cartridge having the above structure, the detected member is driven by a transmission member which is set to drive the detected member by moving at least a portion thereof along a longitudinal direction of the cartridge body, and there is no need to transmit a force to drive the detected member through a rotary axis of the stirring member, so that not only the risk of deformation or even fracture of the rotary axis of the stirring member is eliminated, but also the flexibility in design of the developing cartridge can be improved and the detection accuracy can be ensured.

### BRIEF DESCRIPTION OF THE DRAWINGS

FIG. 1 is a schematic view of the overall structure of the developing cartridge in Embodiment 1 of the present disclosure.

FIG. 2 is a schematic exploded view of partial structure of the developing cartridge in Embodiment 1 of the present disclosure.

FIG. 3 is a schematic view of the structure of the developing cartridge in Embodiment 1 of the present disclosure with the first end cap omitted.

FIG. 4 is a schematic view of the structure of the second end of the developing cartridge in Embodiment 1 of the present disclosure.

FIG. 5 is a schematic view of another partial structure of the developing cartridge in Embodiment 1 of the present disclosure.

FIG. 6 is a schematic view of the structure of the developing cartridge when the transmission member in Embodiment 1 of the present disclosure is in the second position.

FIG. 7 is a schematic view of the structure of the developing cartridge in Embodiment 1 of the present disclosure at the completion of detection.

FIG. 8 is a schematic view of the overall structure of the developing cartridge when the transmission member in Embodiment 2 of the present disclosure is in a first position.

FIG. 9 is a schematic view of the overall structure of the developing cartridge when the transmission member in Embodiment 2 of the present disclosure is in the second position.

FIG. 10 is a schematic view of the overall structure of the developing cartridge when the transmission member in Embodiment 3 of the present disclosure is in the first position.

FIG. 11 is a schematic view of the overall structure of the developing cartridge when the transmission member in Embodiment 3 of the present disclosure is in the second position.

FIG. 12a is a schematic view of the overall structure of the developing cartridge when the transmission member in Embodiment 4 of the present disclosure is in the second position.

FIG. 12b is a schematic view of the overall structure of the developing cartridge when the transmission member in Embodiment 4 of the present disclosure is in the first position.

FIG. 13a is a schematic view of a partial structure of the developing cartridge when the transmission member in Embodiment 4 of the present disclosure is in the second position.

FIG. 13b is a schematic view of a partial structure of a developing cartridge when the transmission member in Embodiment 4 of the present disclosure is in a first position.

FIG. 14a is a schematic view of the overall structure of the developing cartridge when the transmission member in Embodiment 5 of the present disclosure is in a first position.

FIG. 14b is a schematic view of the overall structure of the developing cartridge when the transmission member in Embodiment 5 of the present disclosure is in the second position.

FIG. 15a is a schematic view of a partial structure of a developing cartridge when the transmission member in Embodiment 5 of the present disclosure is in a first position.

FIG. 15b is a schematic view of a partial structure of the developing cartridge when the transmission member in Embodiment 5 of the present disclosure is in the second position.

FIG. 16 is a schematic view of the overall structure of the developing cartridge in Embodiment 6 of the present disclosure.

FIG. 17 is a schematic exploded view of partial structure of the developing cartridge in Embodiment 6 of the present disclosure.

FIG. 18 is a schematic structural view of a first side of the cartridge body in Embodiment 6 of the present disclosure.

FIG. 19 is a schematic view of the overall structure of the developing cartridge in Embodiment 6 of the present disclosure at another angle.

FIG. 20 is another schematic exploded view of partial structure of the developing cartridge in Embodiment 6 of the present disclosure.

FIG. 21 is a schematic structural view of a second side of the cartridge body in Embodiment 6 of the present disclosure.

FIG. 22 is a schematic view of a partial structure of the developing cartridge in Embodiment 6 of the present disclosure.

FIG. 23 is a schematic view of the overall structure of the developing cartridge in Embodiment 7 of the present disclosure.

FIG. 24 is a schematic view of a partial structure of the developing cartridge in Embodiment 7 of the present disclosure.

FIG. 25 is a view of the assembly relationship of the driving member, the transmission member, and the detected member in Embodiment 8 of the present disclosure.

FIG. 26 is a view of the assembly relationship of the driving member, the transmission member, and the detected member in Embodiment 9 of the present disclosure.

FIG. 27 is a schematic view of the partial structure of the driving member and transmission member in Embodiment 9 of the present disclosure.

FIG. 28 is a schematic view of the overall structure of the developing cartridge in Embodiment 10 of the present disclosure.

FIG. 29 is a schematic view of the overall structure of another view of the developing cartridge in Embodiment 10 of the present disclosure.

FIG. 30 is a schematic exploded view of partial structure of the developing cartridge in Embodiment 10 of the present disclosure.

FIG. 31 is a schematic exploded view of partial structure of a first end of the developing cartridge in Embodiment 10 of the present disclosure.

FIG. 32 is a schematic view of the structure of the cam member and the second gear member in Embodiment 10 of the present disclosure.

FIG. 33 is a schematic structural view of the first end cap and the second protruding portion of the Embodiment 10 of the present disclosure.

FIG. 34 is a schematic view of the structure of a first end of the cartridge body in Embodiment 10 of the present disclosure.

FIG. 35a to FIG. 35c are views showing the assembly relationship of components of the developing cartridge in Embodiment 10 of the present disclosure during the inspection process.

FIG. 36 is a schematic view of the overall structure of the developing cartridge in Embodiment 11 of the present disclosure.

FIG. 37 is a schematic view of a partial structure of a first end of the developing cartridge in Embodiment 11 of the present disclosure.

FIG. 38a to FIG. 38c are views showing the assembly relationship of components of the developing cartridge in Embodiment 11 of the present disclosure during the inspection process.

FIG. 39 is a schematic view of a partial structure of the developing cartridge in Embodiment 12 of the present disclosure.

FIG. 40 is a schematic view of another partial structure of the developing cartridge in Embodiment 12 of the present disclosure.

FIG. 41 is a schematic view of the overall structure of the developing cartridge in Embodiment 12 of the present disclosure.

### DETAILED DESCRIPTION OF THE EMBODIMENTS

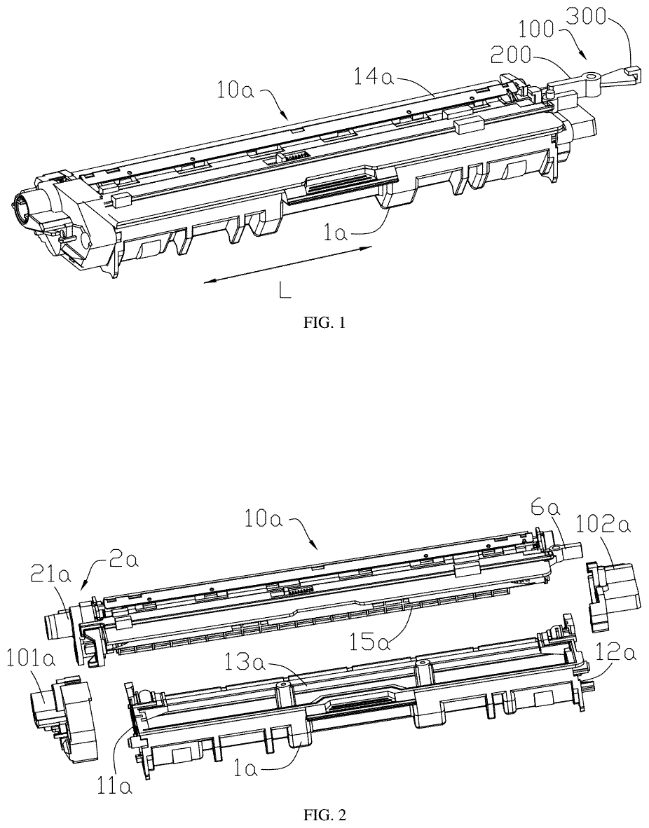

Embodiments disclose a developing cartridge of an imaging apparatus, the imaging apparatus comprises a main assembly and a detection unit 100 (see FIG. 1), a photoconductor drum, and a drive transmission member disposed in the main assembly, the detection unit 100 and the drive transmission member are disposed on different sides of the main assembly. The detection unit 100 is provided on one side of the main assembly for detecting information of a developing cartridge mounted in the main assembly, and is provided with a transmission mechanism 200 (see FIG. 1), which can receive a force of the developing cartridge and pivot, and the imaging apparatus determines the information of the developing cartridge by the situation in which the pivoting motion of the transmission mechanism 200 obscures the sensor 300 (see FIG. 1). The drive transmission member is provided on the other side of the main assembly for transmitting a drive force to the developing cartridge. The structure and detection principle of the imaging apparatus can be referred to the structure and detection principle of the printer disclosed in Chinese Patent Publication No. CN105759586A, and relevant prior art will not be repeated herein.

Hereinafter, the structure of the developing cartridge will be described in detail in connection with the embodiments.

### Embodiment 1

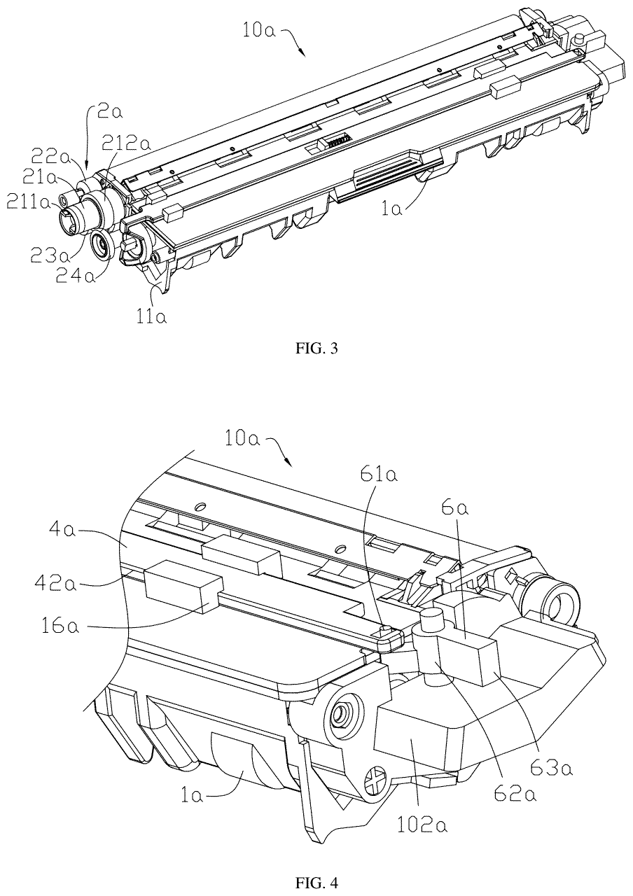

As shown in FIGS. 1 to 3, the developing cartridge 10a is removably mountable in the main assembly of the above-described imaging apparatus. The specific structure of which includes cartridge body 1a and drive force receiving unit 2a.

The cartridge body 1a is substantially cuboid in shape and is provided with a first side wall 11a and a second side wall 12a along the longitudinal direction L thereof. It generally includes a powder compartment 13a for accommodating developer, a development roller 14a, a powder feed roller, and a stirring member 15a. The development roller 14a is disposed on the front side of the developing cartridge 10a in the direction in which the developing cartridge 10a is mounted in the imaging apparatus, and is exposed from the front side of the cartridge body 1a and opposed to the photoconductor drum when the developing cartridge 10a is mounted in the imaging apparatus, to enable development work to be carried out. The powder feed roller faces the development roller 14a and is configured to deliver developer to the development roller 14a; and the stirring member 15a is configured to stir the developer accommodated in the powder compartment 13a.

The drive force receiving unit 2a is provided at a first side (or a first end of the developing cartridge 10a) along the longitudinal direction L of the cartridge body 1a. It is configured to receive a drive force from a drive transmission member of the imaging apparatus and transmit a rotational drive force to rotational members such as the development roller 14a. The drive force receiving unit 2a disclosed herein may include a coupling member 21a, or may include a coupling member 21a and one or more of a development roller gear 22a, a powder feed roller gear 23a, a stirring member gear, and an idler wheel 24a. In this embodiment, the drive force receiving unit 2a includes the coupling member 21a, the development roller gear 22a, the powder feed roller gear 23a, and the idler wheel 24a.

The coupling member 21a is rotatably supported on the first side wall 11a of the cartridge body 1a, and its rotational axis extends along the longitudinal direction L of the developing cartridge 10a parallel to the rotational axis of the development roller 14a. The coupling member 21a is provided with a drive force receiving portion 211a and a first gear portion 212a. The drive force receiving portion 211a is coupled with the drive transmission member of the imaging apparatus and receives the drive force. The first gear portion 212a is configured to engage with the development roller gear 22a, the powder feed roller gear 23a, and the idler wheel 24a to transmit a rotary drive force to the development roller gear 22a, the powder feed roller gear 23a, and the idler 24a. The development roller gear 22a and the powder feed roller gear 23a are provided at the ends of the development roller 14a and the powder feed roller, respectively, to rotate the development roller 14a and the powder feed roller. The stirring member gear is provided at an end portion of the stirring member 15a and meshes with the idler wheel 24a to drive the stirring member 15a to rotate.

The developing cartridge 10a is provided with a first end cap 101a and a second end cap 102a at each end of the developing cartridge 10a, the first end cap 101a being disposed on the outer side of the first side wall 11a to protect the drive force receiving unit 2a. The second end cap 102a is disposed on the outer side of the second side wall 12a, from which the detected member 6a (which will be described in more detail later) can be exposed.

As shown in FIGS. 4 to 6, in this embodiment, the developing cartridge 10a is further provided with a driving member 3a, a transmission member 4a, a resilient member 5a, and a detected member 6a.

For ease of description, a direction parallel to a mounting direction P of the developing cartridge 10a is taken as a front-rear direction of the developing cartridge 10a, a position where the development roller 14a is located is taken as a front side of the developing cartridge 10a, and a side opposite to the front side is taken as a back side; a longitudinal direction L of the cartridge body 1a is taken as a right-left direction of the developing cartridge 10a, with a first side wall 11a located on the left side of the developing cartridge 10a and a second side wall 12a located on the right side; the direction perpendicular to the front-rear direction and the left-right direction is the up-down direction T. When the developing cartridge is mounted in the imaging apparatus, the upper side of the developing cartridge is above and the lower side is below.

The driving member 3a is configured to receive a drive force and move. The drive force reception may be direct from the drive force receiving unit 2a or indirect. The drive force may be in the form of a rotational drive force or a pushing force, and the corresponding movement of the driving member 3a may be rotation or sliding.

Preferably, the driving member is provided in a rotatable manner. The driving member may include a main body portion, a second gear portion configured to engage with the drive force receiving unit, and an action portion configured to push the transmission member. The action portion may extend in the direction of the rotational axis of the driving member or in the radial direction.

In this embodiment, the driving member is a cam member 3a, and the action portion is a cam portion. Specifically, the cam member 3a includes a cylindrical main body portion 31a, and the main body portion 31a is provided with a second gear portion 32a configured to engage with the drive force receiving unit 2a and a cam portion configured to push the transmission member 4a. In the present disclosure, the cam portion may be or include a protruding portion extending in the direction of the rotational axis of the cam member or in the radial direction.

In this embodiment, the rotational axis of the cam member 3a is parallel to the longitudinal direction L of the cartridge body 1a, and the cam portion includes two cam portions: a first cam portion 33a and a second cam portion 34a, and the first cam portion 33a and the second cam portion 34a have essentially the same shape and structure, and the first cam portion 33a will be described as an example below.

The first cam portion 33a protrudes from the end face of the main body portion 31a along the longitudinal direction L of the cartridge body 1a. Specifically, this first cam portion 33a protrudes along the longitudinal direction L of the cartridge body 1a in a direction away from the first side wall 11a, and it is also provided with a first guiding surface 35a and a second guiding surface 36a on its side, and in the rotational direction of the cam member 3a, the first guiding surface 35a is located upstream of the second guiding surface 36a. The main body portion 31a is cylindrical in shape, and the two cam portions are provided on the circumference of the main body portion 31a at predetermined spaced intervals.

In this embodiment, the cam member 3a is provided at an end portion of the stirring member 15a, which can serve as a gear for the stirring member 15a, and the second gear portion 32a engages with the idler wheel 24a of the drive force receiving unit 2a to receive a rotational drive force which is configured to drive the stirring member 15a to rotate.

Optionally, the cam member 3a may also be provided at the end of the development roller 14a or the powder feed roller, or may be independently provided on the cartridge body 1a.

The transmission member 4a is configured to receive a force from the driving member 3a to cause at least a portion of the transmission member 4a to move along the longitudinal direction L of the cartridge body 1a. The transmission member 4a is configured to drive the detected member 6a. This driving can be achieved in various ways: the detected member 6a may be fixedly connected to the transmission member 4a or integrally molded it and move along with the movement of the transmission member 4a; the detected member 6a may be movably connected to the transmission member 4a; or the driving can be achieved by the transmission member 4a contacting the detected member 6a.

The transmission member 4a is movable between a first position not pushed by the cam portion and a second position pushed by the cam portion. The transmission member 4a is provided with a force receiving portion 41a that receives a force from the cam portion of the cam member 3a, and the force receiving portion 41a is also configured to be pushed by the cam portion so as to enable the transmission member 4a to move between the first position and the second position.

In this embodiment, the transmission member 4a is a sliding member comprising a force receiving portion 41a and a rod portion 42a. The rod portion 42a extends along the longitudinal direction L of the cartridge body 1a, with at least a portion of it disposed between the first side wall 11a and the second side wall 12a. The rod portion 42a is slidably disposed on the cartridge body 1a, and the cam portion is configured to push the force receiving portion 41a to slide along the longitudinal direction L of the cartridge body 1a.

The cartridge body 1a is provided with a sliding groove portion 16a as an example of an accommodating groove for the transmission member, and the transmission member 4a is at least partially mounted in the sliding groove portion 16a to enable it to slide along the longitudinal direction L of the cartridge body 1a. The number of sliding groove portions 16a may be one or more. The manner of realizing the sliding of the transmission member 4a is not limited to the slide groove method, but may also include the provision of a storage portion for storing the transmission member 4a, or other methods.

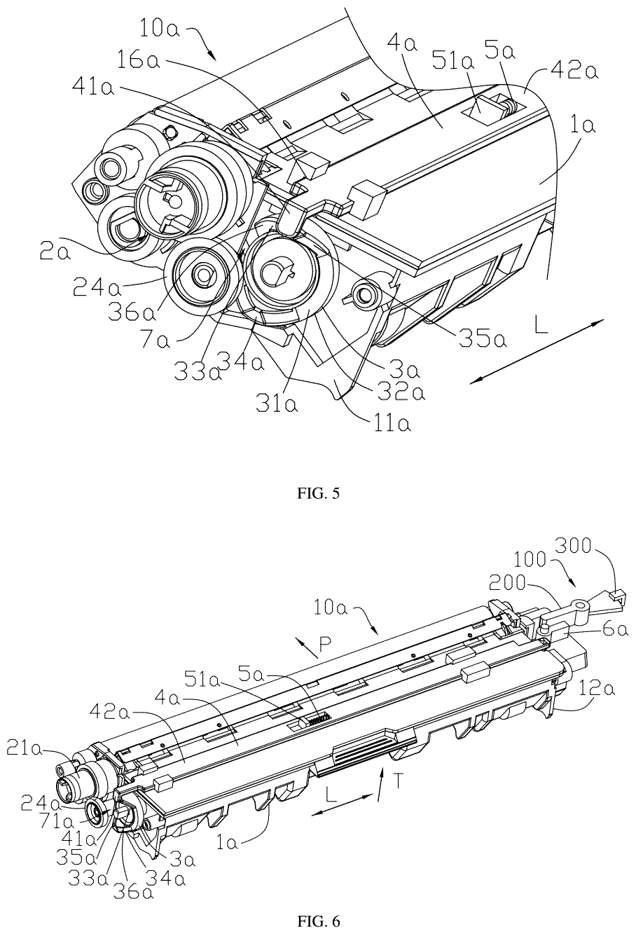

As shown in FIGS. 4 and 5, the sliding groove portion 16a protrudes from an outer surface of the cartridge body 1a and is positioned higher than the transmission member 4a. A side of the sliding groove portion 16a facing the transmission member 4a is configured to contact an outer surface of the transmission member 4a, thereby restricting movement of the transmission member 4a along an up-down direction T of the developing cartridge.

As an example, there may be two sliding groove portions 16a, and the two sliding groove portions 16a are provided on opposite sides of the transmission member 4a. Alternatively, there may be multiple sliding groove portions 16a, and the multiple sliding groove portions 16a are spaced apart along the longitudinal direction L of the cartridge body 1a.

The resilient member 5a is configured to apply a force to the transmission member 4a to enable it to move from the second position towards the first position.

Specifically, the resilient member 5a is a compression spring, one end of which resists the resilient member support 51a on the cartridge body 1a, and the other end of which resists a portion of the transmission member 4a. When the transmission member 4a moves from the first position to the second position, it compresses the resilient member 5a to the left. More specifically, the transmission member 4a has a housing portion in which the resilient member 5a is housed.

Optionally, such a resilient member 5a may also be an extension spring, a torsion spring, or an elastic sponge body, etc.

The detected member 6a is provided at the second end of the developing cartridge 10a and is configured to be driven by the transmission member 4a. This driving may be either direct or indirect. For example, the detected member 6a may be integrally molded with the transmission member 4a, connected in a linkage relationship, or driven at a predetermined distance apart etc. All of these fall within the scope of driving in the disclosure.

In this embodiment, the detected member 6a is pivotally disposed at the second end of the cartridge body 1a and is configured to be driven by the transmission member 4a. Specifically, the detected member 6a is provided with a force receiving portion 61a, a connection portion 62a, and a detected portion 63a, and the connection portion 62a is pivotally connected to a pivot axis on the cartridge body 1a or the second end cap 102a forming a pivoting center.

The force receiving portion 61a extends from the connection portion 62a and is connected to one end of the transmission member 4a in a pivotal manner (e.g., to form a link mechanism). Specifically, the end portion of the rod portion 42a is provided with a circular hole and is movably connected to the shaft portion (force receiving portion 61a) of the detected member 6a, so that when the transmission member 4a moves along the longitudinal direction L of the cartridge body 1a, it can drive the detected member 6a to pivot. The detected portion 63a extends along a direction different from the extension direction of the force receiving portion 61a, so as to be able to trigger the detection unit 100 of the imaging apparatus when the detected member 6a pivots.

It can be understood that in this embodiment, during the pivoting movement of the detected member 6a, the detected member 6a can also be considered to move along a front-rear direction of the cartridge body 1a. In addition, this embodiment does not limit the specific manner in which the detected member 6a moves along the front-rear direction of the cartridge body 1a. For example, it could also move in a linear translation or along an arc-shaped path, which is not limited herein.

In this embodiment, the developing cartridge 10a further comprises a clutch mechanism 7a for interrupting the transmission of the drive force to the transmission member 4a. Specifically, the clutch mechanism 7a includes a notched portion 71a provided on the cam member 3a. The notched portion 71a is provided on the radially outer side of the main body portion 31a of the cam member 3a, and the force receiving portion 41a of the transmission member 4a can fall into the notched portion 71a. When this happens, the force receiving portion 41a is detached from the path through which the rotational process of the cam portion passes, no longer receives a force from the cam portion, thus interrupting the drive force transmission.

The process by which the developing cartridge 10a is detected by the detection unit 100 of the imaging apparatus will now be described with reference to FIGS. 4 to 7.

As shown in FIG. 6, in this embodiment, when the developing cartridge 10a is in an unused state, the transmission member 4a is in the second position (initial position), the resilient member 5a is in a compressed state, and the detected member 6a is in a state where it has not triggered the detection unit 100.

The user installs the developing cartridge 10a into the imaging apparatus, and the coupling member 21a is coupled to a drive transmission member of the imaging apparatus. When the imaging apparatus begins to operate, the idler wheel 24a receives the drive force from the coupling member 21a and rotates the cam member 3a. As the cam member 3a rotates, the force receiving portion 41a moves from the top of the first cam portion 33a along the first guiding surface 35a towards the root of the first cam portion 33a under the pushing of the first cam portion 33a. At this time, under the action of the elastic restoring force of the resilient member 5a, the transmission member 4a slides to the right side, and the detected member 6a rotates and contacts the detection unit 100 of the imaging apparatus, driven by the transmission member 4a.

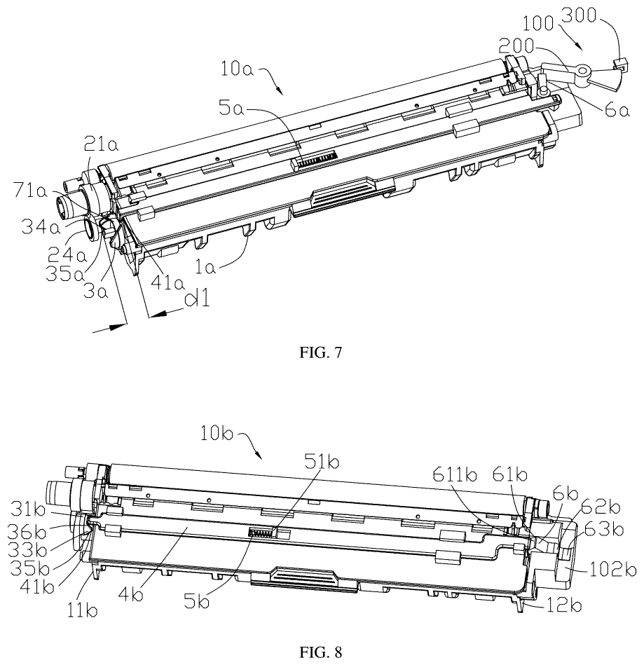

As the cam member 3a continues to rotate, the force receiving portion 41a of the transmission member 4a moves from the root of the cam portion to the top of the second cam portion 34a along the second guiding surface 36a of the second cam portion 34a under the pushing of the second cam portion 34a, at which time the transmission member 4a slides to the left and rotates the detected member 6a, which disengages from the detection unit 100. As the force receiving portion 41a moves along the first guide surface 35a from the top of the second cam portion 34a to the root of the second cam portion 34a, under the action of the elastic restoring force of the resilient member 5a, the transmission member 4a slides to the right and rotates the detected member 6a, causing the detected member 6a to contact the detection unit 100 for a second time. As the cam member 3a continues to rotate, the force receiving portion 41a moves along the end face of the cam member 3a and ultimately falls into the notched portion 71a as shown in FIG. 7. The cam member 3a continues to rotate but the transmission member 4a is no longer pushed, and the detection is completed.

The number of cam portions can be set according to the number of times the detection unit 100 needs to be toggled, for example, one cam portion can be set when it needs to be toggled once, and multiple cam portions can be set when it needs to be toggled multiple time. The structures of different cam portions can also be different, and they can be set according to the strength and amplitude of the pushing force on the transmission member, so as to differentiate between different types or capacities of developing cartridges.

In the developing cartridge 10a with the above-described structure, the transmission member 4a moves at least partially along the longitudinal direction L of the cartridge body 1a. As can be seen with reference to FIG. 7, the transmission member 4a moves along the longitudinal direction L of the cartridge body 1a by a distance d1, which is the same as or greater than the protruding amount (i.e., the distance from the root of the cam portion to the top of the cam portion) of the cam portion.

The developing cartridge 10a with the above-described structure eliminates the need to transmit the drive force for driving the detected member 6a through the rotary shaft of the stirring member 15a, thereby eliminating the risk of deformation or even fracture of the rotary shaft of the stirring member 15a. The adoption of a sliding method to achieve the transmission of the drive force from the first end of the developing cartridge 10a to the second end of the developing cartridge 10a solves the problem of delayed transmission of the drive force caused by the deformation of the rotary shaft of the stirring member 15a, and improves the detection accuracy. Additionally, the torque required for the developing cartridge 10a is greatly reduced, resulting in more stable operation of the developing cartridge 10a.

In some embodiments, the detected member is integrally molded with the transmission member 4a, and the detected member is provided at the end of the transmission member 4a and moves with the movement of the transmission member 4a so as to be configured to trigger the detection unit 100 of the imaging apparatus.

In some embodiments, the detected member 6a is set up as a sliding member, relying on the pushing force of the transmission member 4a for sliding.

In some embodiments, the resilient member 5a is not connected to the transmission member 4a, but is set to be connected to the detected member 6a, which pushes the transmission member 4a to move from the second position towards the first position.

In some embodiments, the detected member does not come into contact with the transmission member, i.e., the two can be spaced apart by a predetermined distance, as long as the detected member 6a can be driven when the transmission member 4a moves.

In some embodiments, the clutch mechanism may also be provided between the drive force receiving unit 2a and the cam member 3a to indirectly interrupt transmission of the drive force to the transmission member 4a by interrupting the transmission of the drive force between the drive force receiving unit 2a and the cam member 3a.

In some embodiments, the driving member 3a is a rack structure engaged with the drive force receiving unit 2a, which receives the drive force to move and is configured to push the transmission member 4a along the longitudinal direction of the developing cartridge.

In some embodiments, the initial position of the transmission member 4a is the first position, and the transmission member 4a drives the detected member 6a to contact the detection unit in the imaging apparatus when it moves from the first position to the second position.

In some embodiments, the detected member 6a may or may not be in contact with the transmission mechanism 200 of the detection unit 100 in an initial position.

In some embodiments, the above variations are combined according to design needs.

### Embodiment 2

This embodiment is an improvement based on Embodiment 1 and its variations, the shape and structure of the developing cartridge in Embodiment 2 are essentially the same as the developing cartridge in Embodiment 1, the same parts will not be repeated, and the following mainly introduces the differences.

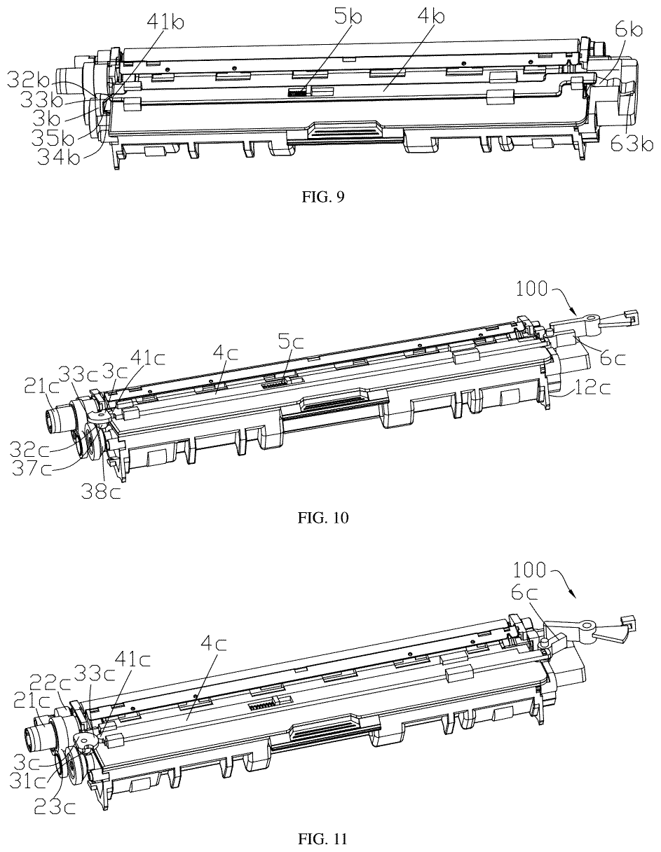

As shown in FIGS. 8 and 9, in the present embodiment, the cam portion protrudes in a direction opposite to the direction of protrusion of the cam portion in Embodiment 1. In this embodiment, there are two cam portions: a first cam portion 33b and a second cam portion 34b. The first cam portion 33b will be described as an example below. The first cam portion 33b protrudes from the end face of the main body portion 31b in a direction towards the first side wall 11b and is configured to push the force receiving portion 41b of the transmission member 4b.

The direction of force applied by the resilient member 5b to the transmission member 4b is towards the leftward direction, and the resilient member support portion 51b is located on the right side of the resilient member 5b. The initial position of the transmission member 4b is in the first position where the force receiving portion 41b of the transmission member 4b abuts against the right side end face of the main body portion 31b.

In this embodiment, the detected member 6b is configured to pivot in the up-down direction along the cartridge body, specifically the detected member 6b is provided with a force receiving portion 61b, a connection portion 62b, and a detected portion 63b, the connection portion 62b is pivotally connected to the second end cap 102b, the force receiving portion 61b extends from the connection portion 62b towards the transmission member 4b. The force receiving portion 61b is also provided with a pressing surface 611b, which, when pressed by the transmission member 4b, causes the detected member 6b to rotate around the pivoting center. The detected portion 63b is provided on the other side of the connection portion 62b, and when the pressing surface 611b is pushed by the transmission member 4b, the detected portion 63b tilts upwardly to be able to trigger the detection unit 100 of the imaging apparatus.

Optionally, the moving direction of the detected portion 63b may be set according to its position relative to the detection unit 100 of the imaging apparatus.

The process by which the developing cartridge 10b is detected by the detection unit 100 of the imaging apparatus will now be described with reference to FIGS. 8 and 9.

As shown in FIG. 8, in this embodiment, when the developing cartridge 10b is in an unused state, the transmission member 4b is in the first position (initial position), the resilient member 5b is not compressed, and the detected member 6b has not triggered the detection unit 100.

When the imaging apparatus begins to operate, the cam member 3b receives a drive force through the second gear portion 32b and rotates, causing the force receiving portion 41b to move from the root portion of the first cam portion 33b along the second guiding surface 36b towards the top portion of the first cam portion 33b under the pushing of the first cam portion 33b. At this time, the transmission member 4b is forced to slide to the right. As shown in FIG. 9, the transmission member 4b is in the second position, the resilient member 5b is compressed, the transmission member 4b presses against the pressing surface 611b of the detected member 6b causing the detected member 6b to rotate, and the detected portion 63b tilts upwardly to contact the detection unit 100 of the imaging apparatus.

As the force receiving portion 41b moves from the top of the first cam portion 33b along the first guiding surface 35b towards the root of the first cam portion 33b, the transmission member 4b is forced to move to the left under the action of the resilient restoring force of the resilient member 5b, the transmission member 4b no longer presses the detected member 6b, and the detected portion 63b of the detected member 6b can move downwardly under its own gravity and return to its initial state. When the second cam portion 34b pushes the force receiving portion 41b of the transmission member 4b, the detected member 6b contacts the detection unit 100 for a second time, and detection is completed.

In some embodiments, the developing cartridge is further provided with a resilient reset member that applies a resilient force to the detected member 6b, enabling the detected member 6b to return to the initial state. Specifically, the resilient reset member may be a compression spring that supports the force receiving portion 61b of the detected member 6b in the upward direction so that the detected member 6b remains at in the initial position.

In some other embodiments, the above variations are combined as needed for the design.

### Embodiment 3

This embodiment is an improvement based on Embodiment 1 and its variations, the shape and structure of the developing cartridge in Embodiment 3 are essentially the same as the developing cartridge in Embodiment 1, and the same parts will not be repeated, and the following mainly describes the differences.

As shown in FIGS. 10 and 11, in this embodiment, the rotational axis of the cam member 3c and that of the coupling member 21c are intersecting (including cases where they intersect in the same plane and where their projections intersect on the same plane).

Specifically, the rotational axis of the cam member 3c is set perpendicular to the rotational axis of the coupling member 21c, and the second gear portion 32c of the cam member 3c is a first bevel gear teeth portion which engages with a second bevel gear teeth portion 38c provided on the stirring member gear. The cam portion 33c of the cam member 3c is provided on the upper side of the cam member 3c, and the cam portion 33c extends outwardly in the radial direction from the main body portion 31c.

In this embodiment, the clutch mechanism includes a missing tooth portion 37c provided on the outer circumferential surface of the main body portion 31c of the cam member 3c, and when the missing tooth portion 37c rotates to face the second bevel gear teeth portion 38c, the transmission of the drive force between the second bevel gear teeth portion 38c and the first bevel gear teeth portion 32c is interrupted.

The force receiving portion 41c of the transmission member 4c is located closer to the second side wall 12c compared to the cam portion 33c. In this embodiment, when the developing cartridge is not in use, the transmission member is in the first position (the position shown in FIG. 10), and the force receiving portion 41c abuts against the root portion of the cam portion. When the second gear portion 32c of the cam member 3c receives the drive force and rotates, the cam portion 33c pushes the force receiving portion 41c, causing the transmission member 4c to slide to the right, driving the detected member 6c to rotate, thereby triggering the detection unit 100 of the imaging apparatus. As shown in FIG. 11, the transmission member 4c is in the second position. As the cam member 3c continues rotating, the force receiving portion 41c moves from the top of the cam portion 33c towards its root, the transmission member 4c slides to the left under the action of the elastic restoring force of the resilient member 5c and drives the detected member 6c to pivot, and the detected member 6c disengages from the detection unit 100, and detection is completed.

In some embodiments, the second bevel gear teeth portion may be provided on the coupling member 21c, the development roller gear 22c, the powder feed roller gear 23c, or the idler wheel 24c.

In some embodiments, the force receiving portion 41c of the transmission member 4c is located further away from the second side wall 12c compared to the cam portion.

In some other embodiments, the above variations are combined as required by the design.

### Embodiment 4

This embodiment is an improvement based on Embodiment 1 and its variations, the shape and structure of the developing cartridge in Embodiment 4 are essentially the same as the developing cartridge in Embodiment 1, and the same parts will not be repeated, and the following mainly describes the differences.

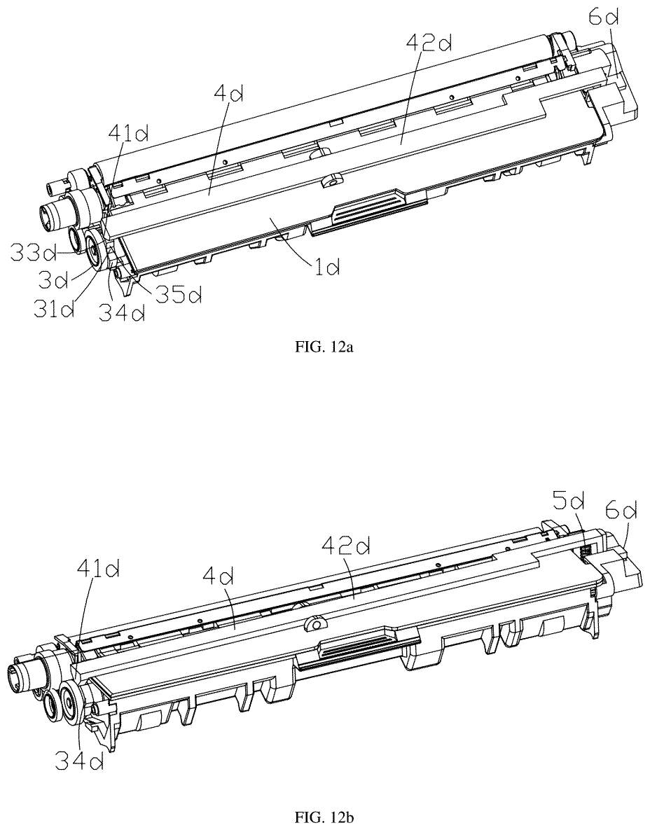

As shown in FIGS. 12a and 12b, in this embodiment, the transmission member 4d is a pivoting member, at least a portion of which is movable along the longitudinal direction L of the cartridge body 1d.

The transmission member 4d comprises a force receiving portion 41d and a rod portion 42d. The middle portion of the rod portion 42d is connected to the cartridge body 1d in a manner that allows it to pivot upwardly and downwardly, such a connection can be achieved by means of a shaft portion and a shaft bore. The force receiving portion 41d is provided at the first end of the rod portion 42d, and it is positioned above the rotational axis of the main body portion 31d to enable the cam portion to push the force receiving portion 41d upwardly.

The driving member is a cam member 3d, the rotational axis of the cam member 3d is set in parallel to the rotational axis of the coupling member 21d, and the cam portion protrudes in the radial direction from the main body portion 31d. In this embodiment, the cam member 3d has two cam portions: a first cam portion 33d and a second cam portion 34d. A root portion of the cam portion is formed between the first cam portion 33d and the second cam portion 34d.

The resilient member 5d is supported at the second end of the rod portion 42d and is provided on the lower side of the second end of the rod portion 42d.

The detected member 6d is fixedly connected to the second end of the transmission member 4d, enabling it to pivot with the pivoting motion of the transmission member 4d.

The process by which the developing cartridge is detected by the detection unit 100 of the imaging apparatus will now be described with reference to FIGS. 12a and 12b.

In this embodiment, when the developing cartridge is not in use, the transmission member 4d is in the second position (as shown in FIG. 12a), the force receiving portion 41d abuts against the top of the first cam portion 33d, the resilient member 5d is compressed, and the detected member 6d has not triggered the detection unit.

When the imaging apparatus begins to operate, as the cam member 3d rotates, the force receiving portion 41d of the transmission member 4d moves towards the root along the first guiding surface 35d of the first cam portion 33d, and under the action of the elastic restoring force of the resilient member 5d, the second end of the rod portion 42d lifts upwardly and drives the detected member 6d upwardly and the detected member 6d then triggers the detection unit in the imaging apparatus, and the transmission member moves to the first position (the position shown in FIG. 12b).

As the cam member 3d continues rotating, the second cam portion 34d pushes the force receiving portion 41d of the transmission member 4d. As a result, the force receiving portion 41d first moves upwardly and then downwardly. Synchronously, the detected member 6d moves downwardly to disengage from the detection unit 100 and then upwardly contacting the detection unit 100 again, thereby completing the detection.

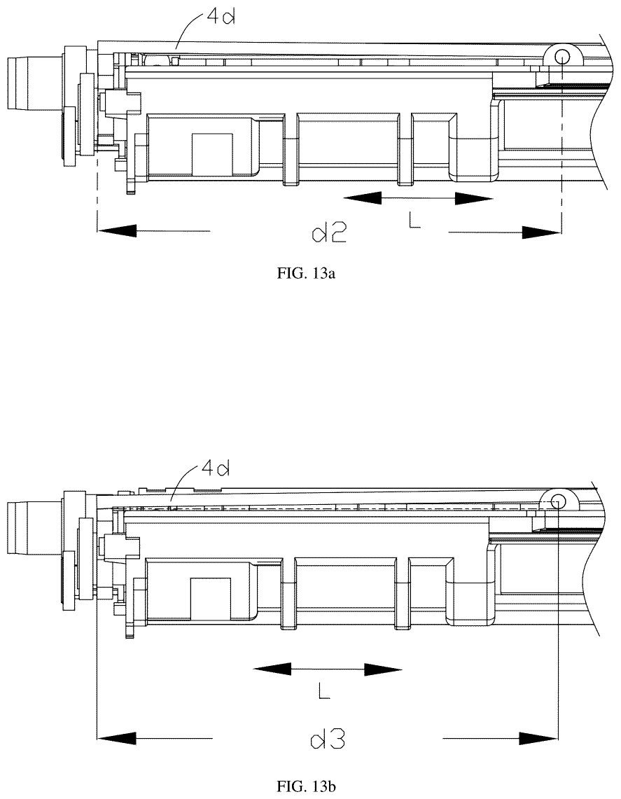

FIG. 13a illustrates the positional state of the transmission member 4d when it is in the second position; and FIG. 13b illustrates the positional state of the transmission member 4d when it is in the first position. As shown in FIG. 13a, when the transmission member 4d is in the second position, the distance from one end of the transmission member 4d to the pivoting center along the longitudinal direction L of the developing cartridge is d2. When the transmission member 4d pivots from the second position to the first position, as shown in FIG. 13b, the distance from the same end of the transmission member 4d to the pivoting center along the longitudinal direction L of the developing cartridge is d3, and d3 is smaller than d2, and the movement distance of this end of the transmission member 4d along the longitudinal direction of the developing cartridge is the difference between d2 and d3.

In some embodiments, the force receiving portion 41d may also be provided on the lower side of the rotational axis of the main body portion 31d, and the detection unit 100 is triggered when the detected portion 63d moves downward.

In some other embodiments, the above variations are combined as required by the design.

### Embodiment 5

This embodiment is an improvement based on Embodiment 4 and its variations, and the shape and structure of the developing cartridge in Embodiment 5 are essentially the same as the developing cartridge in Embodiment 4, and the same parts will not be repeated, and the following mainly describes the differences.

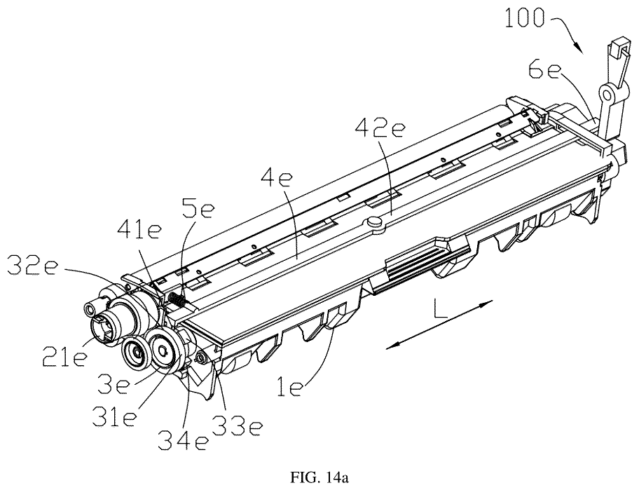

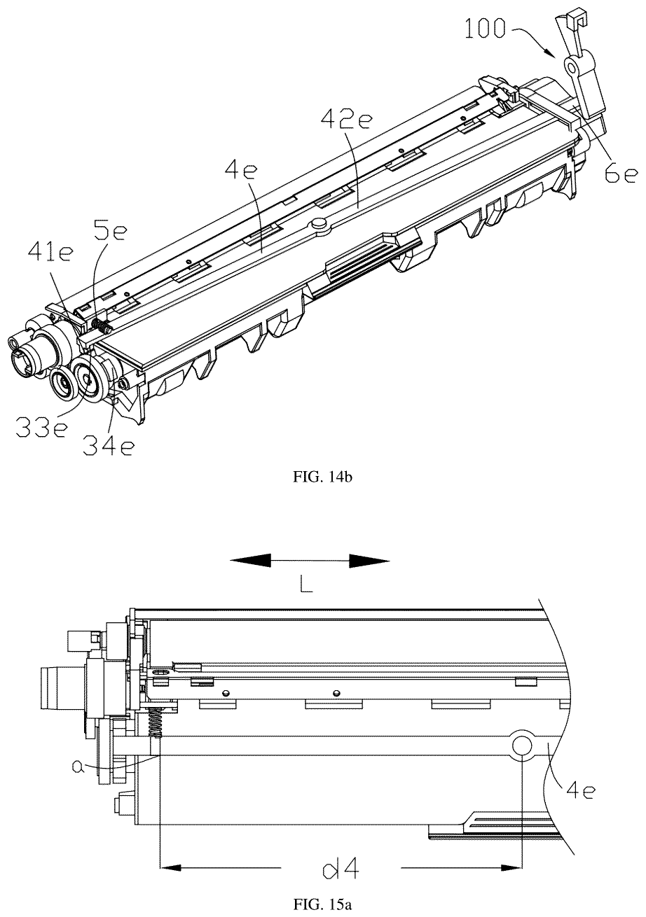

As shown in FIGS. 14a and 14b, in this embodiment, the transmission member 4c is a pivoting member configured to pivot in a front-rear direction of the developing cartridge, and at least a portion of the pivoting member is movable along the longitudinal direction L of the cartridge body 1c.

The transmission member 4c includes a force receiving portion 41e and a rod portion 42e, and the middle portion of the rod portion 42e is connected to the cartridge body 1e in a front-rear pivotal manner, such a connection can be achieved, for example, through a shaft portion and a shaft bore. The force receiving portion 41e is provided at the first end of the rod portion 42e in front of a rotational axis of the cam member 3e, to enable the cam portion to push the force receiving portion 41e forward.

The rotational axis of the cam member 3e is set parallel to the rotational axis of the coupling member 21c, and the cam portion protrudes in the radial direction from the main body portion 31e. In this embodiment, the cam member 3e likewise has a first cam portion 33c and a second cam portion 34c, and a root portion of the cam portion is formed between the first cam portion 33e and the second cam portion 34c.

The resilient member 5e supports the first end of the rod portion 42e and is provided on the front side of the first end of the rod portion 42e, and the detected member 6e is fixedly connected to the second end of the rod portion 42e and is configured to pivot with the pivoting motion of the transmission member 4c.

The process by which the developing cartridge is detected by the detection unit 100 of the imaging apparatus will now be described with reference to FIGS. 14a and 14b.

In this embodiment, when the developing cartridge is not in use, the transmission member 4c is in a first position (the position illustrated in FIG. 14a), the force receiving portion 41e abuts against the circumferential surface of the cam body, and the resilient member 5e is not compressed.

When the imaging apparatus begins to operate, the second gear portion 32e of the cam member 3e receives a drive force and rotates. Driven by the first cam portion 33e, the first cam portion 33e pushes the force receiving portion 41e causing the force receiving portion 41e to move towards the front as shown in FIG. 14b, the second end of the transmission member 4e pivots towards the rear, and the detected member 6e moves towards the rear with the second end of the rod portion 42e to contact the detection unit 100.

When the force receiving portion 41e of the transmission member 4e crosses the top of the first cam portion 33c, under the action of the elastic restoring force of the resilient member 5e, the first end of the rod portion 42e moves towards the rear of the developing cartridge, and the second end of the rod portion 42e drives the detected member 6e in the direction of away from the detection unit 100 towards the front, and when the second cam portion 34e pushes the force receiving portion 41e, the action process of the transmission member 4e and the detected member 6e is the same as when the first cam portion 33e pushes the force receiving portion 41e, resulting in the detection unit 100 of the imaging apparatus being triggered again, thereby completing the detection.

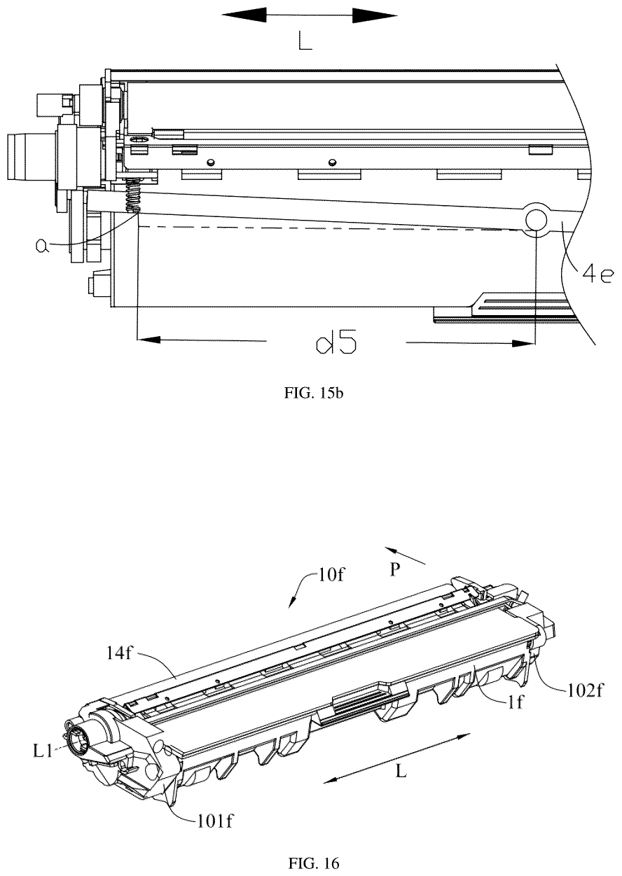

FIG. 15a illustrates the positional state of the transmission member 4e when it is in the first position; and FIG. 15b illustrates the positional state of the transmission member 4e when it is in the second position. As shown in FIG. 15a, when the transmission member 4e is in the first position, the distance from one part a of the transmission member 4e to the pivoting center along the longitudinal direction L of the developing cartridge is d4. When the transmission member 4c pivots from the first position to the second position, as shown in FIG. 15b, the distance from the same part a of the transmission member 4e to the pivoting center along the longitudinal direction L of the developing cartridge is d5, and d5 is smaller than d4, and the movement distance of part a of the transmission member 4c along the longitudinal direction L of the developing cartridge is the difference between d4 and d5.

In some embodiments, the cam portion may also be configured to push the transmission member 4c rearwardly.

In some other embodiments, the above variations are combined as required by the design.

### Embodiment 6

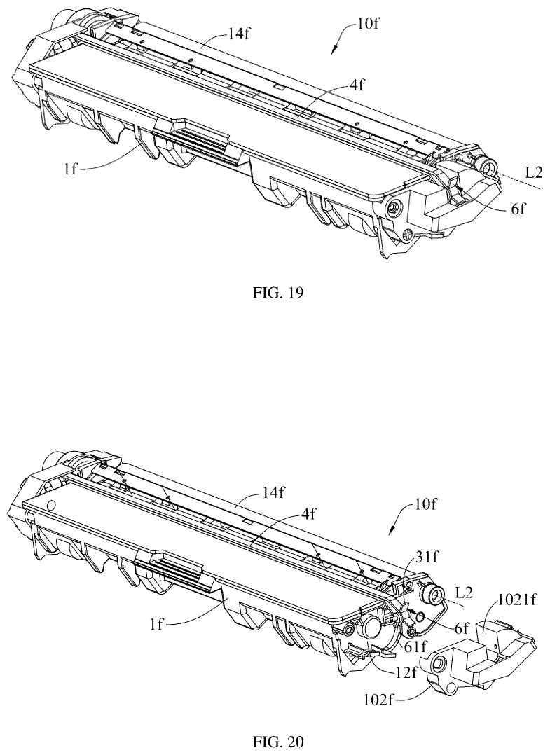

As shown in FIGS. 16 to 22, in Embodiment 6, the cartridge body 1f of the developing cartridge 10f is substantially cuboid in shape, with a first side wall 11f and a second side wall 12f provided externally along its longitudinal direction, and internally it is provided with a powder compartment for accommodating developer, a development roller 14f, a powder feed roller, and a stirring member 15f. The development roller 14f is provided on the front side of the developing cartridge 10f in the mounting direction P towards the imaging apparatus. It is exposed from the front side of the cartridge body 1f and faces the photoconductor drum when mounted in the imaging apparatus for performing development. The powder feed roller faces the development roller 14f and is configured to deliver developer to the development roller 14f. The stirring member 15f is configured to stir the developer accommodated in the powder compartment.

The drive force receiving unit 2f is provided at the first side (or the first end of the developing cartridge) along the longitudinal direction of the cartridge body 1f for receiving a drive force from a drive transmission member of the imaging apparatus and to transmit a rotational drive force to rotating members such as the development roller 14f. Specifically, in this embodiment, the drive force receiving unit 2f includes a coupling member 21f, a development roller gear 22f, a powder feed roller gear 23f, a stirring member gear 24f, and an idler wheel 25f.

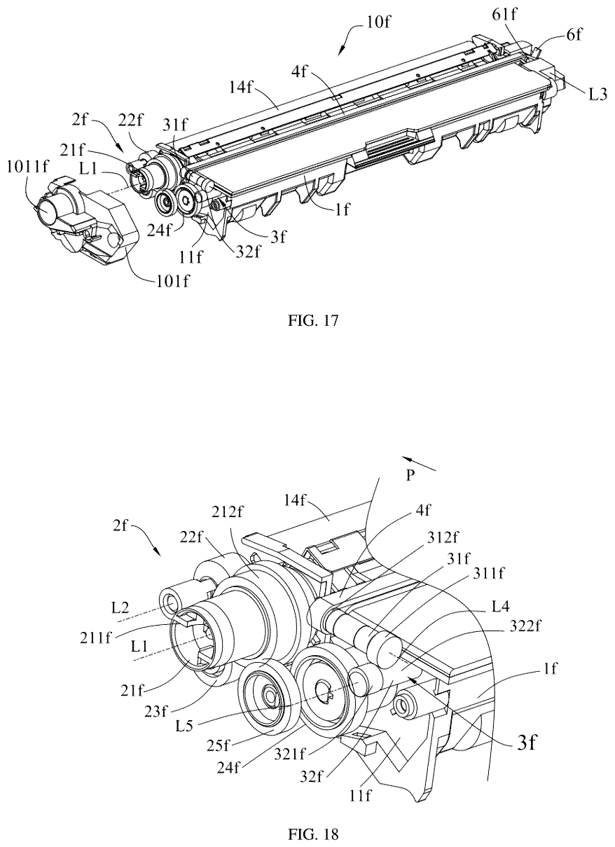

As shown in FIGS. 17 and 18, the coupling member 21f is rotatably supported on the first side wall 11f of the cartridge body 1f, and its rotational axis L1 extends along the longitudinal direction of the developing cartridge 10f parallel to the rotational axis L2 of the development roller 14f. The coupling member 21f is provided with a drive force receiving portion 211f and a gear portion 212f, wherein the drive force receiving portion 211f is coupled to the drive transmission member and receives the drive force, and the gear portion 212f is configured to engage with the development roller gear 22f, the powder feed roller gear 23f, and the idler wheel 25f for transmitting rotational drive force to them. The development roller gear 22f and the powder feed roller gear 23f are provided at the ends of the development roller 14f and the powder feed roller, respectively, to drive the rotation of these components. The stirring member gear 24f is provided at an end portion of the stirring member 15f and engages with the idler wheel 25f to drive the stirring member 15f to rotate.

As shown in FIGS. 20 to 22, the developing cartridge 10f includes the detected member 6f and a support member, and the support member in this embodiment is a rotating body 61f, the rotating body 61f is provided at a second end along the longitudinal direction of the developing cartridge 10f (located opposite to the first end along the longitudinal direction of the developing cartridge 10f), the rotating body 61f is configured to rotate by receiving a drive force transmitted from the coupling member 21f, and the rotating body 61f has a rotational axis L3 that intersects (either spatially or planarly) with the rotational axis L1 of the coupling member 21f and the rotational axis L2 of the development roller 14f, i.e., the rotational axis L3 is not parallel to the rotational axis L1 of the coupling member 21f. In the projection on the plane parallel to the rotational axis L1 and the rotational axis L3, the rotational axis L3 of the rotating body 61f intersects with the rotational axis L1 of the coupling member 21f. The rotating body 61f includes a second mounting portion 611f and a rotating support portion 612f, which allows it to be rotatably supported on the developing cartridge 10f.

The detected member 6f is movable with the rotation of the rotating body 61f. For example, the detected member of may rotate or pivot with the rotation of the rotating body 61f, and is configured to contact a transmission mechanism to cause this transmission mechanism to rotate or pivot, thereby enabling the detected member 6f to be detected by a detection unit in the imaging apparatus.

As shown in FIGS. 17 to 22, the developing cartridge 10f of the present embodiment further comprises a driving member 3f and a transmission member. The driving member 3f comprises a first transmission body 31f and a second transmission body 32f, wherein the second transmission body 32f is configured to receive a drive force from the drive force receiving unit 2f, and the first transmission body 31f receives a drive force from the second transmission body 32f; the transmission member is a flexible transmission member 4f, and the flexible transmission member 4f connects the first transmission body 31f to the rotating body 61f, to drive the rotation of the rotating body 61f.

Specifically, in this embodiment, the first transmission body 31f is provided with a first rotational force receiving portion 311f for receiving a rotational force and a first mounting portion 312f for mounting the flexible transmission member 4f, the first rotational force receiving portion 311f may be a gear portion, and the first mounting portion 312f is preferably a shaft portion of the first transmission body 31f. Preferably, the rotational axis L4 of the first transmission body 31f is perpendicular (including spatially perpendicular and planarly perpendicular) to the rotational axis L1 of the coupling member 21f and the rotational axis L2 of the development roller 14f, and is parallel to the mounting direction P of the developing cartridge 10f.

The second transmission body 32f is provided with a second rotational force receiving portion 321f and a rotational force transmitting portion 322f, and a rotational axis L5 of the second transmission body 32f is parallel to the rotational axis L1 of the coupling member 21f and perpendicular to the rotational axis L4 of the first transmission body 31f. The second rotational force receiving portion 321f is configured to receive a rotational drive force from the drive force receiving unit 2f. The rotational force transmitting portion 322f is connected to the first rotational force receiving portion 311f to transmit rotational drive force to the first transmission body 31f. The second rotational force receiving portion 321f may be a gear portion that meshes with the stirring member gear 24f, and the rotational force transmitting portion 322f may be a screw portion that cooperates with the first rotational force receiving portion 311f.

Preferably, the first transmission body 31f and the second transmission body 32f are both rotatably provided on a first side of the cartridge body 1f (a first end of the developing cartridge) on the same side of the cartridge body 1f as the coupling member 21f. The first rotational force receiving portion 311f of the first transmission body 31f is preferably a first gear portion 311f, and the first mounting portion 312f is an annular groove provided on the shaft portion of the first transmission body 31f, and the annular groove rotates together with the rotation of the first gear portion 311f.

The second rotational force receiving portion 321f of the second transmission body 32f is preferably a second gear portion 321f, and the rotational force transmitting portion 322f is preferably a screw portion 322f that engages with the first gear portion 311f.

The second transmission body 32f is rotatably supported on the first side wall 11f with its second gear portion 321f engaged with the stirring member gear 24f to receive the drive force, and the first gear portion 311f is disposed on the upper side of the screw portion 322f and engages with it to receive a drive force. Along the mounting direction P for the developing cartridge 10f, the first mounting portion 312f of the first transmission body 31f is located at the downstream side of the first gear portion 311f.

The flexible transmission member 4f is configured to connect the first transmission body 31f to the rotating body 61f to transmit a drive force to the rotating body 61f. The flexible transmission member 4f is movable along the longitudinal direction L of the developing cartridge 10f. As an example of the flexible transmission member 4f, it is preferably a flexible belt. The flexible belt may be a leather belt, a rubber belt, or the like. One end of the flexible belt is fitted onto the first mounting portion 312f of the first transmission body 31f, and the other end is fitted onto the second mounting portion 611f of the rotating body 61f (which may be a shaft or an annular groove on the rotating body 61f). This arrangement allows the flexible belt to rotate when the first transmission body 31f rotates, which in turn drives the rotating body 61f. The detected member 6f moves with the rotation of the rotating body 61f.

The flexible transmission member 4f is configured to move along the longitudinal direction L of the developing cartridge 10f while rotating. After the flexible transmission member 4f has moved for a predetermined distance, each portion of the flexible transmission member 4f is configured to move along the longitudinal direction L of the developing cartridge 10f for this same distance. In other words, as the flexible transmission member 4f rotates as a whole, each portion of the flexible transmission member 4f also moves along the longitudinal direction L of the developing cartridge 10f.

The flexible belt is configured to have friction with the first transmission body 31f and the second mounting portion 611f of the rotating body 61f. This allows the first transmission body 31f to drive the flexible belt, and in turn to drive the rotating body 61f. Such friction may be achieved by providing rough surfaces on the flexible belt, the first transmission body 31f, and the rotating body 61f, by adopting a mating structure of protrusions and concave portions, or by using a toothed mating structure.

In this embodiment, the first transmission body 31f, the second transmission body 32f, and the flexible transmission member 4f form a transmission direction-change unit, which is configured to connect the drive force receiving unit 2f to the rotating body 61f to achieve the transmission of the drive force. The transmission direction-change unit is configured to transmit the rotational force of a first object (e.g., the drive force receiving unit) in a first direction to a second object to enable movement of the second object (e.g., the detected member) in a second direction, and the rotational axis of the first object intersects with the movement direction of the second object, and this intersection may be spatial or planar. The movement may be either a linear motion or a rotational or curvilinear motion.

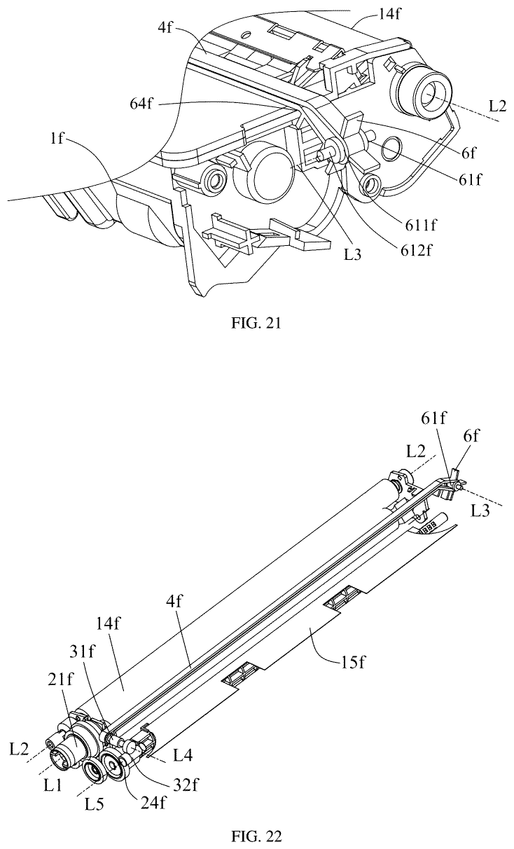

Further, referring to FIG. 21, in this embodiment, the transmission direction-change unit further comprises a direction change body 64f, specifically the direction change body may be a second support member. For example, the flexible transmission member in the form of flexible belt is supported by this second support member to bend downwardly from the upper side to change its direction. Optionally, the direction change body 64f may also be a roller.

In this embodiment, the detected member 6f is provided on an outer surface of the flexible transmission member in the form of flexible belt, and protrudes from this outer surface. There may be one or more detected members 6f. In this embodiment, multiple detected members 6f are spaced at predetermined distances apart. This arrangement allows that when the flexible belt drives the rotating body 61f to rotate, the detected members of may contact the transmission mechanism of the imaging apparatus, thereby causing this transmission mechanism to pivot. Consequently, the imaging apparatus can detect the developing cartridge 10f.

Optionally, the detected member of can also be provided on the rotating body 61f, allowing it to rotate with the rotating body 61f and to contact the transmission mechanism. Alternatively, the detected member of may be removably mounted on the flexible belt or integrally molded with it being able to protrude from the surface of the flexible belt.

In this embodiment, the developing cartridge 10f may also include a first end cap 101f and a second end cap 102f disposed on the first side and the second side, respectively, of the cartridge body 1f. The first end cap 101f covers an outer side of the drive force receiving unit 2f, and the coupling member 21f of the drive force receiving unit 2f may be exposed through a first hole portion 1011f in the first end cap 101f. The second end cap 102f covers the second side of the cartridge body 1f, and the second end cap 102f is provided with an exposure portion 1021f through which the detected member of can be exposed. The rotating body 61f can be rotatably supported on the inner side of the second end cap 102f.

The process by which the developing cartridge 10f is detected by the detection unit in the imaging apparatus will now be described with reference to FIG. 16-FIG. 22.

The user installs the developing cartridge 10f into the imaging apparatus, and the coupling member 21f is coupled to a drive transmission member of the imaging apparatus. When the imaging apparatus starts to operate, the coupling member 21f receives a rotational drive force and rotates, transmitting this rotational force to the second transmission body 32f. The second transmission body 32f then rotates and drives the rotation of the first transmission body 31f through its screw portion 322f. Subsequently, the rotation of the first transmission body 31f then drives the rotation of the flexible belt 4f, which in turn rotates the rotating body 61f of the detected mechanism. As a result, the detected member 6f on the flexible belt 4f contacts the transmission mechanism of the imaging apparatus and is then detected by the imaging apparatus.

In some other embodiments, the second transmission body 32f may receive a rotational drive force from the coupling member 21f, the development roller gear 22f, the powder feed roller gear 23f, or the idler wheel 25f, in addition to receiving a rotational drive force from the stirring member gear 24f.

In some other embodiments, the second transmission body 32f may also be one of the coupling member 21f having a screw portion 322f, the development roller gear 22f, the powder feed roller, or the powder feed roller gear 23f.

In some other embodiments, the rotational force transmitting portion and the first rotational force receiving portion may also form a bevel gear teeth transmission structure (or bevel gear teeth portion), i.e., both the first transmission body 31f and the second transmission body 32f include bevel gear structures, replacing the transmission from the screw portion to the gear with a transmission using beveled teeth. Specifically, the rotational force transmitting portion is in the form of a conical body, the top of this conical body is further away from the first side wall 11f than the bottom, and its sides are provided with conical teeth, and the first rotational force receiving portion is provided with conical teeth, with its rotational axis configured to be perpendicular to the rotational axis of the rotational force transmitting portion.

In some other embodiments, the rotational force transmitting portion and the first rotational force receiving portion may also be connected to each other by a linkage structure such that the rotational axes of the first transmission body and the second transmission body intersect (that is, not parallel).

In some other embodiments, the driving member and the transmission direction-change unit may also be designed without the second transmission body. In this case, the rotational axis of the first transmission body would be configured to be parallel to the rotational axis of the coupling member, with the flexible belt fitted to the first mounting portion of the first transmission body, and its other end fitted to the second mounting portion of the rotating body. Preferably, with the first transmission body and the rotating body at either end, the flexible belt can be divided into a first belt section and a second belt section, and in this variation, the first belt section and the second belt section are non-parallel and are in a cross-over state to drive the rotating body whose rotational axis intersects the rotational axis of the first transmission body to rotate. Optionally, in this configuration, the first transmission body may be the coupling member with a first mounting portion, the development roller gear, the powder feed roller gear, the stirring member gear, or the idler wheel.

In some other embodiments, the flexible transmission member may also be a chain, a rubber band, etc.

In some other embodiments, the support member may also be a component that is fixed to the cartridge body. For example, the rotating body 61f in this embodiment may be replaced with a fixed member. In this case, the fixed member would be fixedly connected to the cartridge body 1f at both ends with the fixed member having a smooth surface. The flexible belt would be fitted on this smooth surface allowing it to slide relative to the fixed member, thereby enabling the detected members disposed on the flexible belt to move and contact the transmission mechanism of the imaging apparatus.

In some other embodiments, depending on the type of imaging apparatus, the rotational axis L3 of the rotating body 61f and the rotational axis L1 of the coupling member 21f may form different angles, such as 90 degrees, 60 degrees, or 30 degrees. This configuration significantly reduces the requirements for precision and improves design flexibility.

In some other embodiments, depending on the type of imaging apparatus, the rotating body 61f may be provided in different positions on the developing cartridge such as on the first side, upper side, lower side or rear side of the cartridge body 1f, which greatly improves the flexibility of the design.

In some other embodiments, the developing cartridge may further comprise a transmission interrupting mechanism (also referred to as a clutch mechanism), the transmission interrupting mechanism is configured to interrupt the drive force transmitted from the first transmission body to the detected member, thereby causing the detected member to stop moving. Specifically, for a structure in which the first transmission body and the flexible belt are driven by friction, the transmission interrupting mechanism may include a smooth surface disposed on the inner side of the flexible transmission member in the form of flexible belt. When this smooth surface moves to a position contacting the first transmission body 31f, the first transmission body 31f becomes unable to transmit the drive force to the flexible belt, resulting in the cessation of the flexible belt's rotation.

In some other embodiments, the above variations may be combined as needed to meet the design requirements.

The developing cartridge having the above-described structure utilizes the flexible transmission member for drive force transmission, this allows for more diverse positioning options for the detected member. Moreover, the rotational axis L3 of the rotating body can be set at an angle to the rotational axis L1 of the coupling member 21f, i.e., it does not need to be parallel, with the angle adjustable as required. This also enhances the flexibility in positioning of the detection unit in the imaging apparatus. The developing cartridge 10f having the above-described structure effectively solves the problem of speed differences arising from long-distance transmission by adopting the flexible transmission member 4f.

Compared to the direct transmission of drive force through gears to the rotating body 61f, the developing cartridge 10f having the above structure requires less stringent consideration of transmission ratios. When the rotational speed of the rotating body 61f needs to be controlled, the gear-based design requires a plurality of gears for deceleration, which would increase the number of parts and raises the production costs. With the flexible transmission member 4f connecting the rotating body 61f and the first transmission body 31f, when the speed of transmission needs to be reduced, it is only necessary to adjust the diameters of the rotating body 61f and the first transmission body 31f, greatly reducing design costs.

The developing cartridge 10f having the structure described above allows for multiple contacts of the transmission mechanism of the imaging apparatus. This can be achieved by providing a plurality of detected members 6f on the flexible transmission member or on the rotating body 61f, or by increasing the number of revolutions. When longer intervals between each contact are required, such a structure is also advantageous.

### Embodiment 7

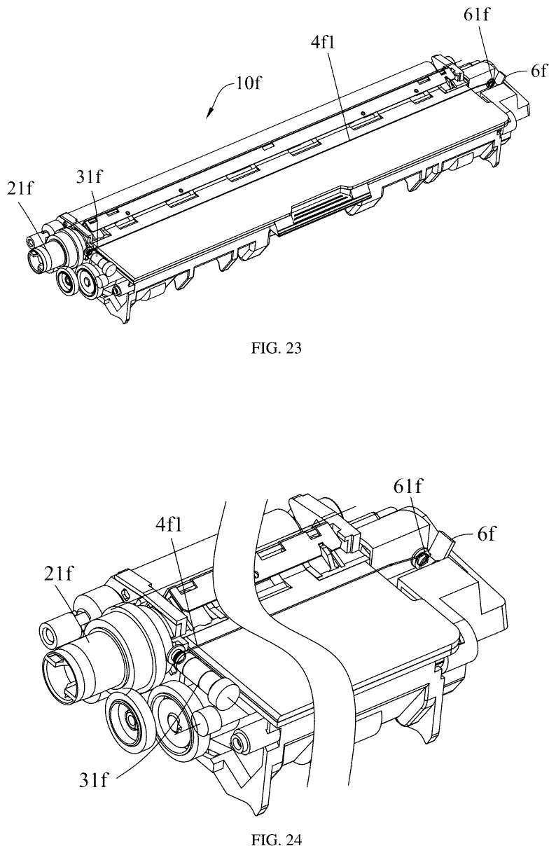

As shown in FIGS. 23 and 24, the shape and structure of the developing cartridge in the present embodiment are basically the same as those of the developing cartridge in Embodiment 6, and the similarities will not be repeated, and the following mainly describes the different aspects.

The flexible transmission member in the present embodiment is a flexible cord 4f1, one end of the flexible cord 4f1 is wound on or attached to the first transmission body 31f, and the other end is wound on the rotating body 61f, and the number of rotational revolutions of the rotating body 61f can be controlled by adjusting the number of turns of the flexible cord 4f1 wound on the rotating body 61f. The flexible cord 4f1 is wound in opposite directions on the first transmission body 31f and the rotating body 61f.

When the developing cartridge 10f is mounted in the imaging apparatus and the coupling member 21f receives the drive force and rotates, the first transmission body 31f receives the drive force and rotates and pulls the flexible cord 4f1. Due to the pulling of the flexible cord 4f1, the rotating body 61f starts to rotate, which causes the detected member 6f disposed on the rotating body 61f to contact the transmission mechanism of the imaging apparatus. In this structure, as the first transmission body 31f and the rotating body 61f rotate, the number of turns wound on the first transmission body 31f increases while the number of turns wound on the rotating body 61f decreases.

In some other embodiments, a direction changing body may also be provided between the first transmission body 31f and the rotating body 61f to change the direction of the transmission. Specifically, the direction changing body may be a roller around which the flexible cord 4f1 changes the direction of the transmission before connecting to the rotating body 61f. Optionally, the direction changing body may also be a fixed second support member with the second support member acting as a fulcrum around which the flexible cord 4f1 wraps around to change its direction.

In some other embodiments, the flexible transmission member may also be a metal wire such as steel wire, iron wire, or other metal wires, or a chain.

In some other embodiments, the developing cartridge may further comprise a transmission interrupting mechanism (clutch mechanism), and the transmission interrupting mechanism is configured to interrupt the drive force transmitted from the drive force receiving unit to the detected member, causing the detected member to stop moving. In this embodiment, the flexible cord or steel wire may not be attached to the rotating body 61f. As a result, as the rotating body 61f rotates, eventually the flexible cord falls off the rotating body 61f, causing the rotating body to stop rotating, and the detected member stops rotating.

For other structures and variations of the developing cartridge in Embodiment 7, please refer to the description in Embodiment 6, which will not be repeated here.

### Embodiment 8

This embodiment is an improvement based on Embodiment 1 and its variations. The shape and structure of the developing cartridge in Embodiment 8 are essentially the same as the developing cartridge in Embodiment 1. The same parts will not be described again; the following mainly focuses on the differences.

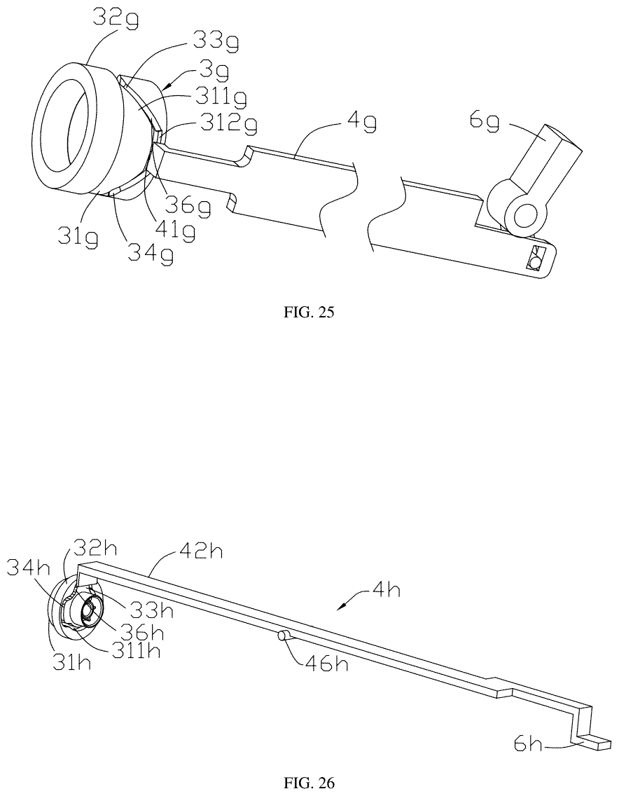

As shown in FIG. 25, in this embodiment, the driving member is a grooved cam wheel member 3g having a rotational axis parallel to the rotational axis of the coupling member. The grooved cam wheel member 3g includes a cylindrical main body portion 31g, a guide groove 311g provided on a circumferential outer surface of the main body portion 31g, and a second gear portion 32g that is configured to engage with the drive force receiving unit.

The action portion of the driving member is provided within the guide groove 311g (or forms a portion of the guide groove), and the force receiving portion 41g of the transmission member 4g is embedded into the guide groove 311g along the radial direction of the main body portion 31g and is configured to move along the guide groove 311g as the grooved cam wheel member 3g rotates. Preferably, the embedded portion may be in the form of a cylinder that matches the guide groove 311g.

In this embodiment, there are two action portions: a first action portion 33g and a second action portion 34g, both having the same shape and structure.

Taking the first action portion 33g as an example, it extends along a direction away from the first side wall along the direction of the rotational axis of the grooved cam wheel member 3g in order to push the force receiving portion 41g of the transmission member 4g when the grooved cam wheel member 3g rotates.

The process by which the developing cartridge is detected by the detection unit in the imaging apparatus will now be described with reference to FIG. 25.

In this embodiment, when the developing cartridge is not in use, the force receiving portion 41g of the transmission member 4g abuts against the side wall 312g of the guide groove 311g, and the detected member 6g is in a state separated from the detection unit.

When the grooved cam wheel member 3g receives the drive force and rotates, the force receiving portion 41g is pushed by the first action portion 33g first moving from the root to the top of the first action portion 33g, then moving from the top back to the root of the first action portion 33g. As a result, the transmission member 4g slides to the left and then to the right, and synchronously, the detected member 6g rotates and then returns to its initial position after contacting the detection unit in the imaging apparatus. As the grooved cam wheel member 3g continues to rotate, the second action portion 34g pushes the force receiving portion 41g and repeats the cooperative action process between the first action portion 33g and the force receiving portion 41g. This allows the detected member 6g to contact the detection unit again and complete the detection.

The developing cartridge having the above structure allows for the omission of the resilient member. The transmission member relies on the guide groove to prevent the force receiving portion from detaching from the grooved cam wheel member 3g.

### Embodiment 9

This embodiment is an improvement based on Embodiment 4 and its variations, and the shape and structure of the developing cartridge in Embodiment 9 are essentially the same as the developing cartridge in Embodiment 4, and the same parts will not be repeated, and the following mainly describes the differences.

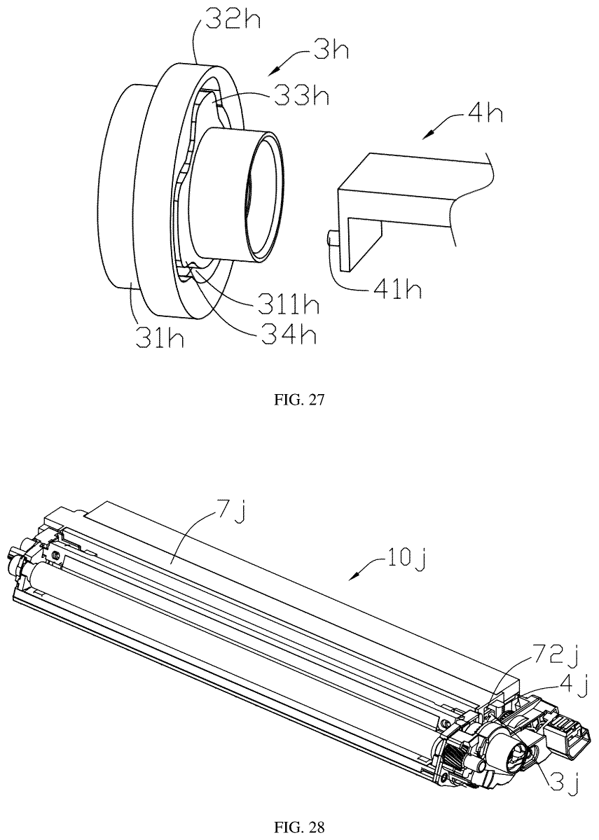

As shown in FIGS. 26 and 27, in this embodiment, the driving member is a grooved cam wheel member 3h having a rotational axis parallel to the rotational axis of the coupling member. The grooved cam wheel member 3h comprises a cylindrical main body portion 31h. A guide groove 311h is provided on an end face of the main body portion 31h near the first side wall, and a second gear portion 32h configured to engage with the drive force receiving unit is provided on its circumferential outer face.

The action portion of the driving member is provided within the guide groove 311h (or forms a portion of the guide groove). The force receiving portion 41h of the transmission member 4h is embedded into the guide groove 311h along the direction of the rotational axis of the main body portion 31h and is configured to move along the guide groove 311h when the grooved cam wheel member 3h rotates.

In this embodiment, there are two action portions: a first action portion 33h and a second action portion 34h with the same shape and structure. Taking the first action portion 33h as an example, the first action portion 33h extends along the radial direction from the main body portion 31h in order to push the force receiving portion 41h of the transmission member 4h when the grooved cam wheel member 3h rotates.

The transmission member 4h is configured to pivot up and down around a shaft portion 46h located in its center, which includes a rod portion 42h and a force receiving portion 41h, and the end of the rod portion 42h located remote from the grooved cam wheel member 3h is fixedly connected to the detected member 6h.

The process by which the developing cartridge is detected by the detection unit in the imaging apparatus will now be described with reference to FIGS. 26 and 27.

In this embodiment, when the developing cartridge is not in use, the transmission member 4h is in the second position where the force receiving portion 41h is located at the top of the first action portion 33h, and the detected member 6h is in a state where it has not contacted the detection unit.

When the grooved cam wheel member 3h receives a drive force and rotates, the force receiving portion 41h moves from the top of the first action portion 33h towards the root of the first action portion 33h, the first end of the rod portion 42h moves downwardly, and the second end of the rod portion lifts upwardly and drives the detected member 6h upwardly. As a result, the detected member 6h triggers the detection unit in the imaging apparatus.

As the second action portion 34h pushes the force receiving portion 41h of the transmission member 4h, the force receiving portion 41h first moves upwardly and then downwardly, and synchronously, the detected member 6h moves downwardly to disengage from the detection unit and then moves upwardly to contact the detection unit again, thereby completing the detection.

The developing cartridge having the above-described structure allows for the omitting of the resilient member, and the transmission member relies on the restrictive effect of the guide groove to prevent it from disengaging from the grooved cam wheel member 3h.

Optionally, the number and shape of the action portions may be varied as needed. For example, one or more action portions may be provided, or a plurality of action portions may have different shapes.

### Embodiment 10

This embodiment is an improvement based on Embodiment 1 and its variations, and the shape and structure of the developing cartridge 10j in Embodiment 10 are essentially the same as that of the developing cartridge 10a in Embodiment 1, and the same parts will not be repeated, and the following mainly describes the differences.

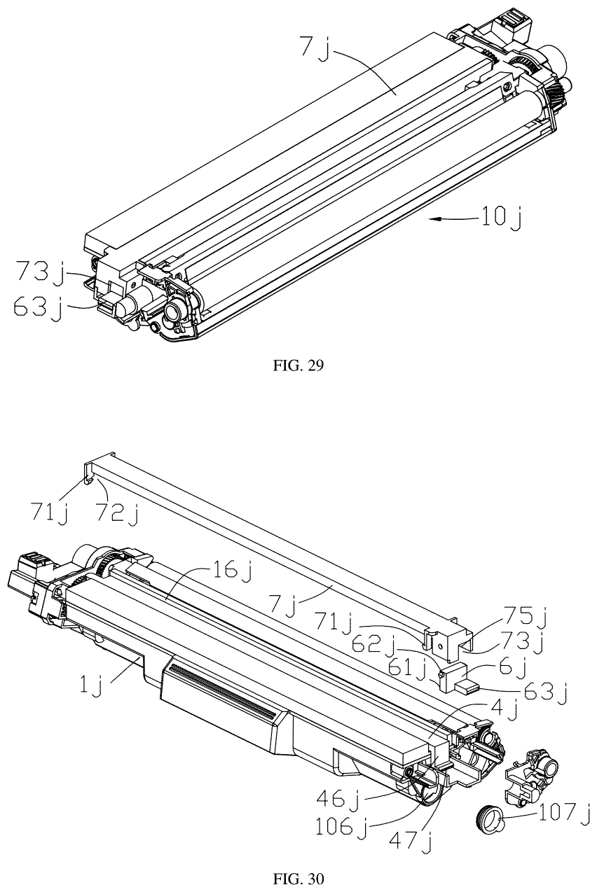

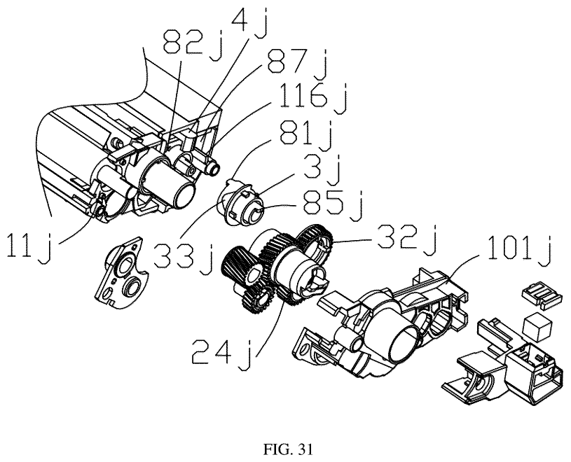

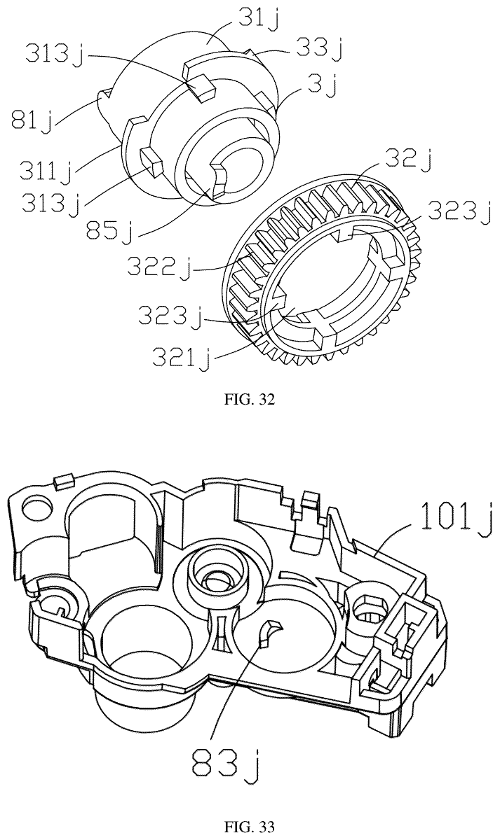

As shown in FIGS. 28 to 34, the driving member in the present embodiment is configured as a cam member, and the developing cartridge 10j is provided with a clutch mechanism for interrupting the transmission of the drive force to the detected member 6j at a predetermined time. The clutch mechanism includes a forcing structure and a retracting structure, the forcing structure is designed to force at least a portion of the cam member 3j to move, and the retracting structure provides a displacement space for this portion of the cam member to move. Specifically, the retracting structure includes a first protruding portion 81j provided at the end of the cam member 3j near the first side wall 11j and a yielding portion 82j disposed on the support member 87j. Specifically, the yielding portion is in the form of an opening 82j.

The first protruding portion 81j can move against the surface of the support member 87j, and when the first protruding portion 81j moves to the opening 82j, it falls into the opening 82j under the action of the forcing structure, causing the cam member 3j to move.

The support member 87j is fixedly connected to the first side wall or replaces it. The forcing structure includes a second protruding portion 83j provided on the first end cap 101j and a third protruding portion 85j provided on the end of the cam member 3j away from the first side wall 11j. The second protruding portion 83j and the third protruding portion 85j protrude in opposite directions. This arrangement allows that upon rotation of the cam member 3j, the third protruding portion 85j moves along the pressure surface of the second protruding portion 83j towards the top of the second protruding portion 83j, thereby forcing the cam member 3j to move along the longitudinal direction of the developing cartridge 10j and interrupts the transmission of the drive force.

The interplay between the forcing structure and the retracting structure is such that the first protruding portion 81j moves first to the opening 82j before the second protruding portion 83j pushes the third protruding portion 85j. Alternatively, as the second protruding portion 83j pushes the third protruding portion 85j, the first protruding portion 81j may move to the opening 82j at the same time. This structure allows the developing cartridge 10j to omit the resilient member. The structure is simpler, and assembly is more convenient.

The cam member 3j in this embodiment further includes a main body portion 31j, a cam portion 33j, and a rotational force receiving portion 313j, the main body portion 31j is substantially cylindrical in shape, with a flange portion 311j provided on it outer circumference. A third protruding portion 85j protrudes outwardly from the side of the cam member 3j away from the first side wall 11j, and is designed to abut against the inner side of the first end cap 101j. The first protruding portion 81j protrudes from the main body portion 31j in a direction towards the first side wall 11j. The cam portion 33j is provided on a side of the flange portion 311j proximate to the first side wall 11j, and protrudes in the direction towards the first side wall 11j in order to form a fit with the transmission member 4j. The rotational force receiving portion 313j is configured to protrude from the circumferential outer side of the main body portion 31j in the radial direction of the main body portion 31j to receive the drive force. The second gear member 32j includes a hollow portion 321j, a gear portion 322j, and a rotational force transmitting portion 323j, and the hollow portion 321j is cylindrically hollow, which is configured to be fitted onto the outer side of the cam member 3j.

The rotational force transmitting portion 323j protrudes from the inner wall of the hollow portion 321j in the radial direction of the second gear member 32j, and is configured to engage with the rotational force receiving portion 313j of the cam member 3j. This allows the rotational force transmitting portion 323j to drive the rotational force receiving portion 313j to rotate when the second gear member 32j rotates, and when the cam member 3j moves along the longitudinal direction of the developing cartridge 10j, the rotational force transmitting portion 323j and the rotational force receiving portion 313j become disengaged along the longitudinal direction of the developing cartridge, thereby interrupting the transmission of the rotational drive force.

In this embodiment, the developing cartridge further comprises a restriction portion that restricts the movement of the second gear member 32j. Specifically, the restriction portion is in the form of a protrusion 116j disposed on the first side wall 11j, the protrusion 116j abuts against the end of the second gear member 32j closest to the first side wall 11j. It is configured to restrict the second gear member 32j from moving with the cam member 3j during relative movement between the cam member 3j and the second gear member 32j. This enables a better separation between the rotational force transmitting portion 323j and the rotational force receiving portion 313j. Preferably, a plurality of restriction portions may be provided on both the end cap and the side wall.

The upper side of the cartridge body 1j is provided with a sliding groove portion 16j, and the transmission member 4j is slidably accommodated in the sliding groove portion 16j. Specifically, the upper surface of the transmission member 4j is flush with or lower than the upper surface of the cartridge body 1j.

The developing cartridge 10j further comprises a covering portion 7j that at least partially covers the transmission member 4j, the covering portion 7j in the present embodiment is in the form of an elongated strip that is configured to be snapped onto the cartridge body 1j to cover the transmission member 4j.

Specifically, the covering portion 7j is provided with snap-fit portions 71j, a first exposed portion 72j, and a second exposed portion 73j at its ends. The snap-fit portions 71j disposed at the ends are snapped onto the cartridge body 1j to secure the covering portion 7j. The first exposed portion 72j and the second exposed portion 73j are configured as openings. One end of the transmission member 4j can extend through the first exposed portion 72j to cooperate with the cam member 3j. The detected portion 63j of the detected member 6j can be exposed through the second exposed portion 73j in order to cooperate with the detection unit in the imaging apparatus.

The detected member 6j is supported on the second end of the covering portion 7j in a manner allowing it to pivot in the up-down direction, and the second end of the covering portion 7j is provided with an accommodating cavity 75j to accommodate a portion of the detected member 6j.

Specifically, the connection portion 62j of the detected member 6j is pivotally attached to the covering portion 7j, the pivot axis of the connection portion 62j is located above the force receiving portion 61j. The detected portion 63j is located below the pivot axis and below the transmission mechanism 200j of the detection unit when mounted in the imaging apparatus. The detected portion 63j can trigger the transmission mechanism 200j when it pivots up and down.

In this embodiment, the second end of the transmission member 4j further comprises a bending section 46j which bends downwardly and connects to a drive portion 47j. The drive portion 47j of the transmission member 4j extends along the longitudinal direction of the developing cartridge 10j. The detected member 6j is pivotally supported on the covering portion 7j, and the force receiving portion 61j is located below the pivot axis of the connection portion 62j. When the drive portion 47j of the transmission member 4j triggers the force receiving portion 61j of the detected member 6j, the detected member 6j pivots. As a result, the detected portion 63j moves upwardly to trigger the detection unit so as to be able to be detected.

In this embodiment, when the developing cartridge 10j is mounted in the imaging apparatus, the detected portion 63j of the detected member 6j is pressed against the transmission mechanism 200j (which has a resilient force). As a result, the force receiving portion 61j of the detected member 6j pushes the transmission member 4j towards the right side causing the transmission member 4j to be firmly pressed against the flange portion 311j of the cam member 3j.

When the cam portion 33j of the cam member 3j pushes the transmission member 4j, the transmission member 4j moves towards the right side of the developing cartridge 10j, which in turn pushes the detected member 6j to pivot. Consequently, the detected portion 63j of the detected member 6j moves upwardly pushing against the rotation of the transmission mechanism 200j of the detection unit enabling detection.

When the force receiving portion 41j of the transmission member 4j moves from the top of the cam portion 33j towards the root, the detected member 6j pushes the transmission member 4j towards the left side of the developing cartridge 10j under the action of the pressing force of the transmission mechanism 200j.

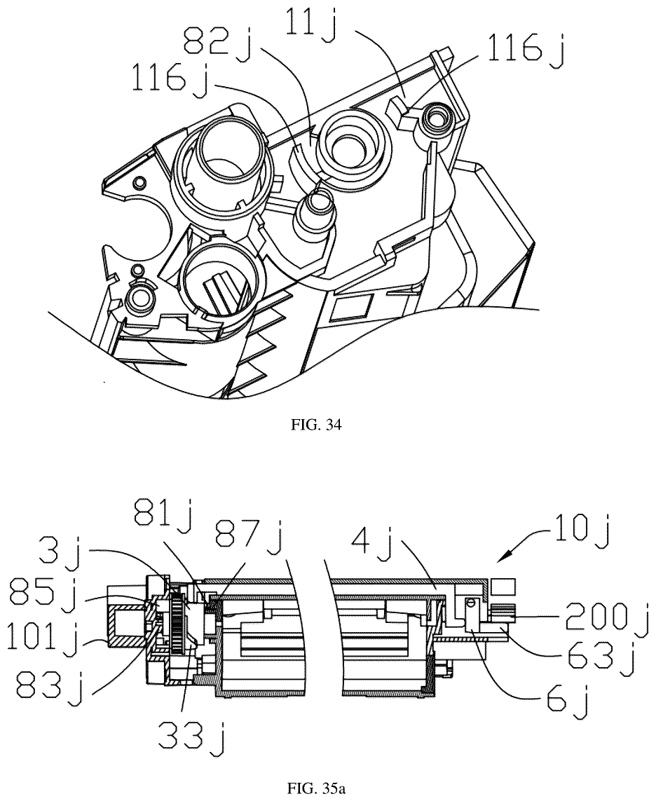

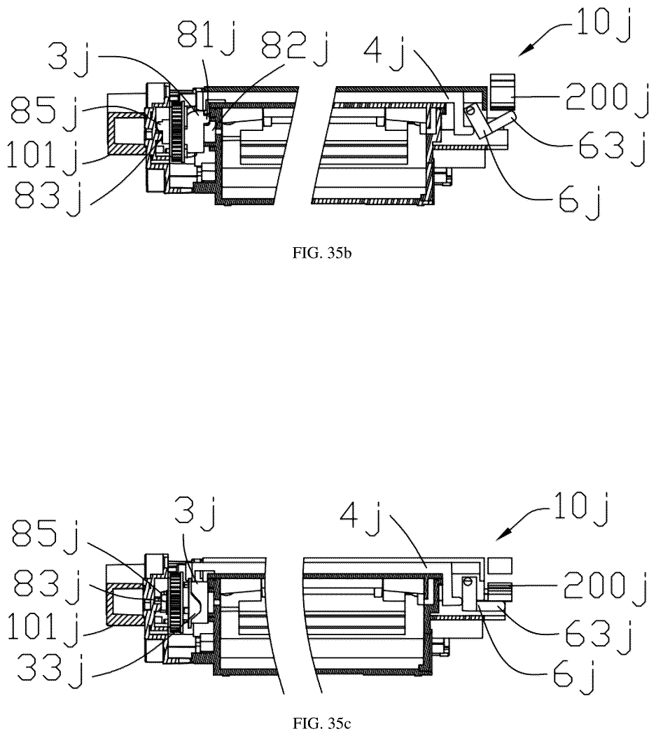

The interaction of the components of the developing cartridge 10j as it is detected by the imaging apparatus will now be described with reference to FIGS. 35a to 35c.

As shown in FIG. 35a, when the developing cartridge 10j is mounted in the imaging apparatus, the detected portion 63j of the detected member 6j is pressed by the transmission mechanism 200j, the transmission member 4j is pressed against the cam member 3j, the third protruding portion 85j is pressed against the inner wall of the first end cap 101j, and the first protruding portion 81j is pressed against the support member 87j.

As shown in FIG. 35b, when the cam portion 33j pushes the transmission member 4j. As a result, the transmission member 4j pushes the detected member 6j, and the detected portion 63j of the detected member 6j pivots upwardly and pushes the transmission mechanism 200j enabling detection to occur.

As shown in FIG. 35c, as the cam member 3j rotates and the cam portion 33j disengages from the transmission member 4j, the transmission mechanism 200j elastically returns to press the detected portion 63j downwardly returning it to its initial position.

When the second protruding portion 83j pushes the third protruding portion 85j, the first protruding portion 81j is disposed at the opening 82j, thereby causing the cam member 3j to move to the right side. As a result, the rotational force receiving portion 313j of the cam member 3j is disconnected from the rotational force transmitting portion 323j of the second gear member 32j. Consequently, the transmission of the rotational force is interrupted and detection is completed.

With this structure, the developing cartridge 10j is provided with a sliding groove portion 16j, which improves the sliding effectiveness for the transmission member 4j and reduces the contacting and interference from the external environment. The developing cartridge 10j is provided with a covering portion 7j, which effectively protects the transmission member 4j and the detected member 6j from external collisions and interference. Moreover, the developing cartridge 10j in the present embodiment may omit the second end cap, reducing the number of parts and lowering production costs.

The developing cartridge 10j in the present embodiment further comprises a toner filling port 106j and a filling cover 107j. The toner filling port is disposed on the second side wall 12j of the developing cartridge and connects to the powder compartment. A chip and a chip holder may also be provided at the first end of the developing cartridge.

In some embodiments, the second protruding portion 83j can move along the pressing surface of the third protruding portion 85j to the top of the third protruding portion 85j to force the cam member 3j to move along the longitudinal direction of the developing cartridge 10j.

In some embodiments, the second gear member 32j may be integrally molded with or fixedly connected to the cam member 3j. In this case, when the cam member 3j moves along the longitudinal direction of the developing cartridge 10j, the second gear member 32j becomes disengaged from the idler wheel 24j of the drive force receiving unit, thereby interrupting the transmission of the drive force.

In some embodiments, the second protruding portion 83j may not be provided on the end cap, but instead on a component that is fixedly connected to the cartridge body.

In some embodiments, the detected portion may not contact the transmission mechanism 200j when the developing cartridge is first loaded into the imaging apparatus.

In some embodiments, the developing cartridge may comprise a resilient reset member that allows the transmission member to return to its initial position when not pushed by the cam portion.

In some embodiments, a rack structure may be used instead of a cam member. In this case, a protruding portion for driving the transmission member can be provided on the rack, and the rack receives the drive force through its tooth portions causing the rack to move. Subsequently, the protruding portion drives the transmission member to move.

In some embodiments, the forcing structure may also be a cooperative structure of a helical groove and a projection. For example, a helical groove extending along the longitudinal direction of the developing cartridge may be provided on the end cap, and a projection that cooperates with the helical groove may be provided on the cam member. In this arrangement, when the cam member rotates, the projection moves along the helical groove resulting in movement along the longitudinal direction of the developing cartridge.

### Embodiment 11

This embodiment is an improvement based on Embodiment 10 and its variations, and the shape and structure of the developing cartridge 10m in Embodiment 11 are essentially the same as the developing cartridge 10j in Embodiment 10, and the same parts will not be repeated, and the following mainly describes the differences.

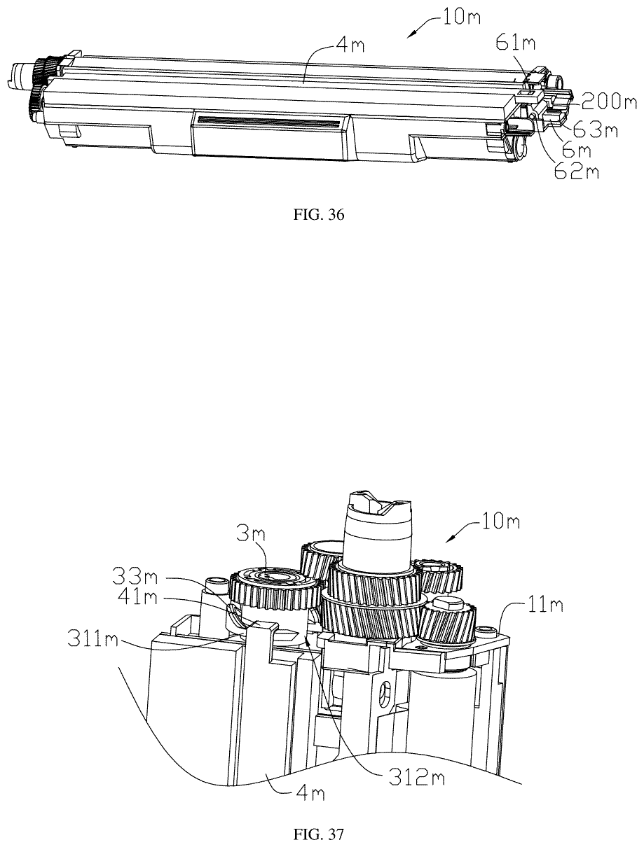

As shown in FIGS. 36 and 37, the developing cartridge 10m comprises a clutch mechanism. Specifically, the clutch mechanism includes a notched portion 312m. the specific notched portion 312m is provided on the flange portion 311m, the cam portion 33m protrudes from the flange portion 311m along the longitudinal direction of the developing cartridge 10m in a direction away from the first side wall 11m. Additionally, the flange portion 311m also has the notched portion 312m. When the transmission member 4m falls into the notched portion 312m, the cam member 3m interrupts the transmission of force to the transmission member 4m.

The transmission member 4m is in the form of a rod, one end of which is positioned against the flange portion 311m of the cam member 3m allowing it to be driven by the cam portion 33m, and the other end of which is connected to the detected member 6m allowing it to drive the detected member 6m to move.

The detected member 6m is supported at the second end of the covering portion in a manner allowing it to pivot in the up-down direction. Specifically, the force receiving portion 61m of the detected member 6m extends upwardly and is inserted into an opening or groove at the second end of the transmission member 4m allowing it to drive the detected member 6m when the transmission member 4m moves left or right.

The connection portion 62m of the detected member 6m is pivotally attached to the covering portion, and the pivot axis of the connection portion 62m is located below the force receiving portion 61m, and the detected portion 63m is located below the force receiving portion 61m and below the transmission mechanism 200m of the detection unit when mounted in the imaging apparatus, and the detected portion 63m can trigger the transmission mechanism 200m when it pivots up and down.

In this embodiment, when the developing cartridge 10m is mounted in the imaging apparatus, the detected portion 63m of the detected member 6m is pressed against the transmission mechanism 200m. As a result, the force receiving portion 61m of the detected member 6m pushes the transmission member 4m towards the right side causing the transmission member 4m to be firmly pressed against the cam member 3m.

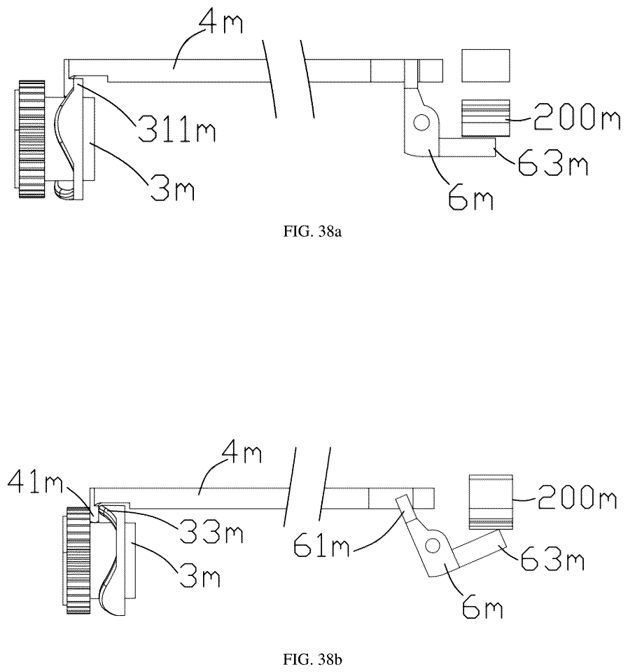

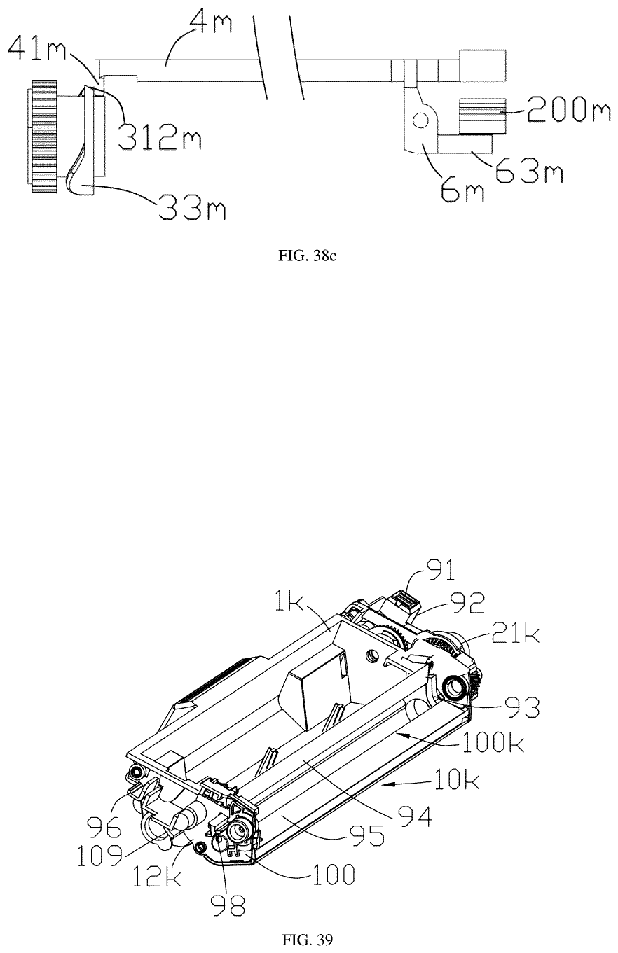

The coordination of the various components during the process of the developing cartridge being detected by the imaging apparatus will now be described with reference to FIGS. 38a through 38c.

As shown in FIG. 38a, when the developing cartridge 10m is mounted in the imaging apparatus, the detected portion 63m of the detected member 6m is pressed by the transmission mechanism 200m, and the transmission member 4m is pressed against the flange portion 311m of the cam member 3m.

As shown in FIG. 38b, when the cam portion 33m of the cam member 3m pushes the force receiving portion 41m of the transmission member 4m, the transmission member 4m moves towards the left side of the developing cartridge 10m, which in turn pivots the force receiving portion 61m of the detected member 6m. Consequently, the detected portion 63m of the detected member 6m moves upwardly pushing against the rotation of the transmission mechanism 200m of the detection unit enabling detection.

As shown in FIG. 38c, when the force receiving portion 41m of the transmission member 4m moves from the top of the cam portion 33m towards the root, the detected member 6m drives the transmission member 4m towards the right side of the developing cartridge 10m under the action of the pressing force of the transmission mechanism 200m.

When the force receiving portion 41m of the transmission member 4m moves to the notched portion 312m, under the action of the pressing force of the transmission mechanism 200m, the force receiving portion 41m of the transmission member 4m falls into the notched portion 312m, pushed by the detected member 6m. It then moves to the right side of the developing cartridge 10m under the action of the force from the transmission mechanism 200m. The cam member 3m continues to rotate but the force receiving portion 41m is no longer driven by the cam portion 33m. As a result, the transmission of force is interrupted.

This structure of the developing cartridge results in a simple clutch mechanism and low manufacturing cost.

### Embodiment 12

This embodiment is an improvement based on the preceding embodiments and their variations. The shape and structure of the developing cartridge 10k in Embodiment 12 are essentially the same as the developing cartridges in the preceding embodiments, and the same parts will not be repeated, and the following mainly describes the differences.

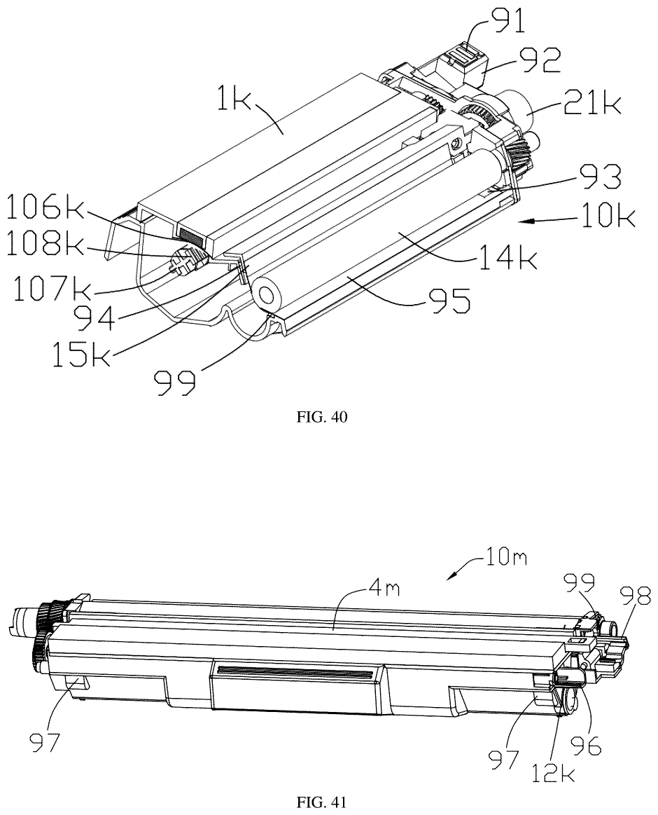

As shown in FIGS. 39 to 41, the developing cartridge 10k in the present embodiment is further provided with a chip 91 and a chip mounting bracket 92 for mounting the chip 91. The chip mounting bracket 92 is configured to be mounted to the cartridge body 1k. Specifically, the chip 91 and the chip mounting bracket 92 are provided at the first end (also the drive end) of the developing cartridge 10k, positioned farther from the development roller 14k than the coupling member 21k.

In some embodiments, the developing cartridge 10k may be removably mounted to a drum cartridge having a photoconductive drum. In this configuration, the developing cartridge 10k would be mounted together with the drum cartridge into the imaging apparatus. The drum cartridge may further comprise a pressure applying member, a locking member, and a separation member. The pressure applying member is configured to apply a force to the developing cartridge 10k mounted in the drum cartridge causing the development roller 14k and the photoconductor drum to come in contact with or close proximity to each other for performing developing operations. The locking member is used for locking and releasing the developing cartridge 10k when mounted in the drum cartridge. Specifically, the locking member is a rotatable component including a locking portion and a pushing portion. The separating member is configured to receive a force from the separating mechanism of the imaging apparatus and push the developing cartridge 10k causing the development roller 14k to move away from the photoconductor drum when an imaging operation is not being carried out. This results in the development roller 14k separating from the photoconductor drum.

The developing cartridge 10k has a locked portion 96, a forcing portion 97, a pushed portion 109, and a separation force receiving portion 98 on the second side wall 12k of the cartridge body 1k. The locked portion 96 protrudes from the rear side of the second side wall 12k and is designed to be snap-fit with the locking member on the drum cartridge when the developing cartridge 10k is mounted in the drum cartridge. The forcing portion 97 is configured to receive a force from the pressure applying member causing the development roller 14k and the photoconductor drum to contact or come close to each other. Specifically the forcing portion 97 is provided at and protrudes from the rear side of the cartridge body 1k, and the forcing portion 97 is provided in a more rearward position than the locked portion 96. The separation force receiving portion 98 protrudes from the second side wall 12k and is designed to receive the action force from the separation member. This causes the developing cartridge 10k to move in a direction away from the photoconductor drum, thereby achieving separation between the photoconductor drum and the development roller 14k. The separation force receiving portion 98 is located nearer to the development roller 14k than the locked portion 96. The pushed portion 109 receives an action force from the pushing portion of the locking member causing the developing cartridge to pivot, thereby causing the locked portion 96 to disengage from the locking portion. Specifically, the pushing portion pushes the pushed portion 109 from its lower side. The pushed portion 109 is positioned between the locked portion 96 and the separating force receiving portion 98.

When projected along the longitudinal direction of the developing cartridge 10k, the separation force receiving portion 98 is located at on or near the line connecting the center of rotation of the development roller 14k to the rotational axis of the coupling member 21k. The separation force receiving portion 98 is disposed nearer to the development roller 14k than the locked portion 96 and the forcing portion 97. Specifically, the separation force receiving portion 98 protrudes from the second side wall 12k along the longitudinal direction of the developing cartridge 10k passing through a through-hole located in the bearing member 100. This bearing member 100 is mounted on the second side wall 12k of the cartridge body 1k.

A sealing assembly is also provided between the cartridge body 1k of the developing cartridge 10k and the development roller 14k, the powder feed roller, and the powder discharge knife 15k to prevent toner from leaking through the gaps between these components. Specifically, in this embodiment, the sealing assembly comprises a first sealing member 93, a second scaling member 94, and a third sealing member 95. The first sealing member 93 is provided at the two ends of the longitudinal direction of the opening portion of the cartridge body 1k to seal the gap between the development roller 14k and the cartridge body 1k. Specifically, the first sealing member 93 may be made of felt.

The second sealing member 94 is in the form of an elongated strip provided between the powder discharge knife 15k and the cartridge body 1k. It is positioned on the rear side of the opening portion 100k to seal the gap between the powder discharge knife 15k and the cartridge body 1k. The second sealing member 94 may be made of sponge. The third sealing member 95 is provided between the development roller 14k and the cartridge body 1k. It is positioned on the front side of the opening portion 100 to seal the gap between the development roller 14k and the rear side of the opening portion. The third sealing member 95 may be in the form of a resilient wiper or sheet.

The joints between the first sealing member 93 and the second sealing member 94 and between the first sealing member 93 and the third sealing member 95 may be created through an interference fit or filled with glue. The first sealing member 93, the second sealing member 94, and the third sealing member 95 are connected to form an annular sealing body. This sealing body surrounds the opening portion 100k.

The powder compartment of the developing cartridge is also provided with a stirring member. This stirring member comprises a shaft portion 107k and a stirring portion 108k extending outwardly from the shaft portion 107k. Additionally, a concave portion 106k is provided at the top of the powder compartment. The concave portion 106k allows to prevent the stirring portion 108k from interfering with the side wall of the powder compartment during rotation.

In some embodiments, a support member 99 is provided between the third sealing member 95 and the cartridge body 1k. This support member 99 is in the form of an elongated strip that supports the third sealing member 95, allowing it to be tilted at an angle.

In some embodiments, the separation force receiving portion 98 and the bearing member can be made electrically conductive. In this configuration, the separation force receiving portion 98 can receive electrical power from the imaging apparatus and pass it through the bearing member to components such as the development roller 14k.

Across various embodiments and their variations, the movement direction of the detected member can also be simply changed as required. Additionally, the position of the detected member can also be flexibly designed, greatly improving the flexibility of the design of the developing cartridge. Furthermore, by adjusting the position of the detected member, it facilitates the miniaturization of the developing cartridge.

Throughout the various embodiments and their variations, the detected member is driven by a transmission member, with at least a portion moving along the longitudinal direction of the cartridge body to drive the detected member. This design eliminate the rotary shaft of the stirring member, which not only eliminates the risk of the need for using the rotational shaft of the stirring member being prone to deformation or even fracture, but also solves the problem of delayed transmission of drive force due to deformation of the rotary shaft of the stirring member to transmit the driving force to the detected member. Consequently, this not only eliminates the risk of deformation or even breakage of the rotational shaft of the stirring member, but also solves the problem of delayed transmission of the drive force due to deformation of the rotational shaft of the stirring member, and improves the detection accuracy.

Finally, it should be noted that, unless there are contradictory or mutually exclusive circumstances, the different embodiments and their variations disclosed above may be cited, referred to, or combined with each other. Additionally, the technical features of different embodiments and their variations may also be combined and/or replaced with each other.

The aforementioned embodiments are provided to exemplify the technical solution of the present disclosure and are not intended to be limiting thereof. To facilitate the differentiation of different components, the present disclosure introduces terms such as “first”, “second”, etc. However, the terms “first”, “second”, etc. are not to be understood as quantitative limitations on these components. For example, when the driving member described in the present disclosure is described as having a second gear portion, it should not be interpreted to mean that the driving member necessarily has a first gear portion or a third gear portion.

According to the description provided, the parts described as “first”, “second”, and the like may be singular or may include a plurality of parts. The terms “upper”, “upper side”, “lower”, and “lower side” are based on the illustrations in the accompanying drawings and are not intended as specific limitations on their orientation. Although the present disclosure has been described in detail with reference to the foregoing embodiments, a person of ordinary skill in the art should understand that it is still possible to modify the technical solutions described in the foregoing embodiments or to replace some or all of the technical features therein with equivalent ones. Such modifications or replacements should not be considered to alter the essence of the corresponding technical solutions or extend beyond the scope of the technical solutions of the embodiments described in the present disclosure.

What is claimed is:

1. A developing cartridge removably mountable in a main assembly of an imaging apparatus, comprising:
a cartridge body;
a drive force receiving unit comprising a coupling member, provided at a first end of the developing cartridge and configured to receive a drive force from the imaging apparatus;
a driving member, provided at the first end of the developing cartridge and configured to receive the drive force and move;
a transmission member configured to receive a force from the driving member, wherein the force causes at least a portion of the transmission member to move in a longitudinal direction of the cartridge body; and
a detected member, provided at a second end of the developing cartridge and configured to be driven by the transmission member.

2. The developing cartridge according to claim 1, wherein the detected member is configured as a sliding member, and is configured to slide in response to a pushing force from the transmission member.

3. The developing cartridge according to claim 1, wherein the drive force receiving unit further comprises a stirring member gear, and the driving member is configured to engage with the stirring member gear.

4. The developing cartridge according to claim 1, wherein the driving member comprises a cam member, the cam member comprising a main body portion and a cam portion configured to push the transmission member, and wherein the cam portion protrudes from an end face of the main body portion along the longitudinal direction of the cartridge body.

5. The developing cartridge according to claim 1, wherein the cartridge body is provided with a sliding groove portion, and at least a portion of the transmission member is disposed in the sliding groove portion.

6. The developing cartridge according to claim 5, wherein the sliding groove portion protrudes from an outer surface of the cartridge body and is positioned higher than the transmission member, and wherein a side of the sliding groove portion facing the transmission member is configured to contact an outer surface of the transmission member, thereby restricting movement of the transmission member along an up-down direction of the developing cartridge.

7. The developing cartridge according to claim 5, wherein the sliding groove portion is provided on an upper side of the cartridge body, the transmission member is slidably accommodated in the sliding groove portion, and an upper surface of the transmission member is flush with or lower than an upper surface of the cartridge body.

8. The developing cartridge according to claim 5, wherein
two sliding groove portions are provided on opposite sides of the transmission member; or
multiple sliding groove portions are spaced apart along the longitudinal direction of the cartridge body.

9. The developing cartridge according to claim 5, wherein the detected member is configured to move in a front-rear direction of the developing cartridge.

10. The developing cartridge according to claim 1, further comprising a rotating body configured to receive the drive force transmitted by the coupling member and rotate, wherein the detected member is configured to rotate or pivot with the rotation of the rotating body.

11. The developing cartridge according to claim 10, wherein the driving member comprises a first transmission body, a rotational axis of the first transmission body being perpendicular to a rotational axis of the coupling member, wherein the first transmission body is provided with a first rotational force receiving portion for receiving rotational force, the first rotational force receiving portion comprising a gear portion.

12. The developing cartridge according to claim 11, wherein the transmission member comprises a flexible transmission member, the flexible transmission member connecting the first transmission body and the rotating body; wherein rotation of the first transmission body is configured to drive the flexible transmission member to rotate and move along the longitudinal direction of the cartridge body, thereby causing the rotating body to rotate through the flexible transmission member.

13. The developing cartridge according to claim 10, wherein the driving member comprises a first transmission body and a second transmission body, wherein the second transmission body is configured to receive a drive force from the drive force receiving unit, the first transmission body receiving the drive force from the second transmission body; wherein both the first transmission body and the second transmission body comprise bevel gear structures.

14. The developing cartridge according to claim 10, wherein the detected member is provided on the rotating body and is configured to rotate with the rotating body.

15. The developing cartridge according to claim 10, wherein the driving member comprises a first transmission body and a flexible transmission member; wherein one end of the flexible transmission member is wound on or connected to the first transmission body, and the other end is wound on the rotating body, with the winding directions of the flexible transmission member on the first transmission body and the rotating body being opposite to each other.

16. The developing cartridge according to claim 12, wherein the detected member is provided on and protrudes from an outer surface of the flexible transmission member.

17. The developing cartridge according to claim 10, wherein the transmission member comprises a flexible transmission member configured to operatively connect the driving member and the rotating body, thereby causing the rotating body to rotate; and
the driving member comprises a first transmission body and a second transmission body, the first transmission body is provided with a first rotational force receiving portion for receiving rotational force and a first mounting portion for mounting the flexible transmission member, the second transmission body is provided with a second rotational force receiving portion and a rotational force transmitting portion, wherein the second rotational force receiving portion is configured to receive rotational drive force from the drive force receiving unit, and the rotational force transmitting portion is connected to the first rotational force receiving portion to transmit rotational drive force to the first transmission body.

18. The developing cartridge according to claim 17, wherein the first rotational force receiving portion comprises a first gear portion, the first mounting portion comprises an annular groove provided on a shaft portion of the first transmission body, the annular groove rotating with the rotation of the first gear portion; wherein the second rotational force receiving portion comprises a second gear portion, and the rotational force transmitting portion comprises a screw rod portion that meshes with the first gear portion for transmission.

19. The developing cartridge according to claim 17, further comprising a direction changing member, wherein the flexible transmission member is supported by the direction changing member to change direction by bending downward from an upper side.

20. The developing cartridge according to claim 17, further comprising a transmission interruption mechanism configured to interrupt the drive force transmitted from the first transmission body to the detected member, thereby causing the detected member to stop moving; wherein the transmission interruption mechanism comprises a smooth surface provided on an inner side of the flexible transmission member, such that when the smooth surface moves to a position in contact with the first transmission body, the flexible transmission member stops rotating.
